(19) United States
(12) Patent Application Publication
(10) Pub. No.: US 2018/0161723 A1
(43) Pub. Date: Jun. 14, 2018

(54) HYGROSCOPIC MATERIAL, METHOD OF PRODUCING SAME, PACKAGING MATERIAL, AND PACKAGING ITEM

(71) Applicant: FUJIFILM CORPORATION, Tokyo (JP)

(72) Inventor: Atsushi KODO, Shizuoka (JP)

(21) Appl. No.: 15/891,378

(22) Filed: Feb. 8, 2018

Related U.S. Application Data
(63) Continuation of application No. PCT/JP2016/078880, filed on Sep. 29, 2016.

(30) Foreign Application Priority Data
Sep. 30, 2015 (JP) 2015-195102
Sep. 28, 2016 (JP) 2016-189771

(51) Int. Cl. B01D 53/28; B01J 20/04; B01J 20/28; B01J 20/30; B32B 27/26; B32B 27/30

(52) U.S. Cl. CPC B01D 53/28; B01J 20/046; B01J 20/28047; B65D 81/264; B32B 27/26; B32B 27/30; B01J 20/3007

(57) ABSTRACT

Provided are a hygroscopic material which includes a resin layer, a hygroscopic layer, and a damp-proof layer in this order, in which the hygroscopic layer has a pattern structure having a first region that has a thickness A and a second region that is present at a peripheral edge of the first region and has a thickness smaller than the thickness A, and the damp-proof layer is provided on the first region and the second region; a method of producing the same; a packaging material; and a packaging item.

### CROSS-REFERENCE TO RELATED APPLICATION

This application is a continuation application of International Application No. PCT/JP2016/078880, filed Sep. 29, 2016, the disclosure of which is incorporated herein by reference in its entirety. Further, this application claims priority from Japanese Patent Application No. 2015-195102, filed Sep. 30, 2015, and Japanese Patent Application No. 2016-189771, filed Sep. 28, 2016, the disclosures of which are incorporated herein by reference in their entirety.

### BACKGROUND OF THE INVENTION

### 1. Field of the Invention

The present invention relates to a hygroscopic material, a method of producing the same, a packaging material, and a packaging item.

### 2. Description of the Related Art

In a dried product such as food or medicine, in order to maintain the humidity inside the packaging to be low so that the contents are protected from the moisture in the air, a small bag or the like that contains a desiccant such as silica gel is usually packed inside the packaging. This packaging is carried out by putting a dried product in a bag-like packaging material, putting a small bag containing a desiccant therein, and sealing the bag-like packaging material. Since a process of putting a small bag containing a desiccant is a process different from a process of putting essential inclusions, this process is usually automated, but the packaging process may become complicated in some cases. Further, in a case of food such as confectionary, a desiccant is enclosed in the food. Therefore, there is a concern that a desiccant is accidentally mixed with the food or a desiccant is accidentally ingested due to breakage of a small bag or the like.

Due to this concern, a film containing a desiccant which can be used as a packaging material has been suggested in place of the small bag containing a desiccant. For example, a desiccant-mixed film formed by kneading a powdery desiccant such as a molecular sieve with a resin has been suggested, and an aspect in which a desiccant-mixed film and a gas barrier film are laminated on each other is disclosed as an aspect for use (for example, see JP3919503B).

A film for dehumidification which is formed of a porous film carrying a hygroscopic agent has been suggested as a packaging material capable of controlling the hygroscopic capacity, the film for dehumidification being formed by sealing the hygroscopic agent with a film capable of controlling moisture permeation having air permeability or moisture permeability, and it is considered that the hygroscopic speed can be controlled by laminating a polyethylene film on one surface or a specific region of the film capable of controlling moisture permeation (see JP1991-114509A (JP-H03-114509A)).

In a laminated film of a desiccant-mixed film and a gas barrier film or a hygroscopic film formed by interposing a desiccant between films, it is difficult to achieve a desired hygroscopic capacity and maintain an excellent hygroscopic capacity for a long period of time in some cases due to permeation of moisture from an end portion of a film to a hygroscopic layer.

For this reason, in order to suppress moisture absorption from an end surface, a packaging material that suppresses moisture permeation by reducing the thickness of a sealant portion of an end portion of the packaging material has been suggested (for example, see JP4450932B). Further, for the purpose of achieving both of functionality and sealability in a film having a functional layer, a laminated film on which a functional layer is formed in a discontinuous pattern shape has been suggested (for example, see JP2014-050988A).

### SUMMARY OF THE INVENTION

However, the method described in JP4450932B has a problem in that productivity is degraded since the position where the thickness of the sealant is reduced needs to be changed according to the size of the packaging material. Further, similarly in sealing processing of an end portion which is typically performed, there is a problem of degraded productivity since sealing is performed according to the size. In addition, since the hygroscopicity of a sealing site is suppressed, there is a problem in that the hygroscopic capacity of the entire hygroscopic material is decreased due to the presence of the sealing portion.

Further, in the laminated film described in JP2014-050988A, since the functional layers are positioned on the side which is in direct contact with the contents, there is a concern that the quality of the film may be changed depending on the contents. Further, a large amount of air is present between the functional layers. Therefore, in a case where the functional layers are hygroscopic layers, the functional layers do not have a function of suppressing moisture transport between the layers even in a case where the functional layers are separated from each other.

According to an embodiment of the present invention, there are provided a hygroscopic material which has a large hygroscopic capacity and is capable of maintaining excellent hygroscopicity for a long period of time even in a case where a sealing treatment is not performed on an end portion; a method of producing the same; a packaging material; and a packaging item.

Specific means for solving the above-described problems includes the following aspects.

<1> A hygroscopic material comprising: a resin layer (preferably a resin layer having moisture permeability; the same applies hereinafter); a hygroscopic layer (preferably a hygroscopic layer having a non-uniform thickness; the same applies hereinafter); and a damp-proof layer in this order, in which the hygroscopic layer has a pattern structure having a first region that has a thickness A and a second region that is present at a peripheral edge of the first region and has a thickness smaller than the thickness A, and the damp-proof layer is provided on the first region and the second region.

<2> The hygroscopic material according to <1>, in which an occupancy ratio of the second region which has a thickness smaller than the thickness A to the entire region of the hygroscopic layer is 10% or greater and less than 50% in terms of area ratio in a plan view.

<3> The hygroscopic material according to <1> or <2>, in which the pattern structure of the hygroscopic layer is a structure having the first region and the second region which is disposed at both edges of the first region in a width direction of the hygroscopic layer and at least one edge of the first region in a direction orthogonal to the width direction (orthogonal direction) of the hygroscopic layer and has a thickness smaller than the thickness A, a plurality of the structures are disposed in a longitudinal direction orthogonal to the width direction of the hygroscopic layer, and the occupancy ratio of the “second region which is present at at least one edge of the first region in the orthogonal direction and has a thickness smaller than the thickness A” to the total of the first region and the second region in the direction orthogonal to the width direction of the hygroscopic layer is 10% or greater and less than 50% in terms of area ratio in a plan view.

<4> The hygroscopic material according to <3>, in which at least one of the second region disposed at both edges of the first region has a width length of 3 mm or greater from an end portion of the hygroscopic layer in the width direction.

<5> The hygroscopic material according to any one of <1> to <4>, in which the thickness A of the hygroscopic layer in the first region is in a range of 20 μm to 50 μm, and the thickness of the hygroscopic layer in the second region having a thickness smaller than the thickness A is less than 20% of the thickness of the hygroscopic layer in the first region having the thickness A.

<6> The hygroscopic material according to any one of <1> to <5>, in which the hygroscopic layer has a porous structure containing amorphous silica particles, a water-soluble resin, and a hygroscopic agent, and the porosity of the hygroscopic layer is in a range of 45% to 85%.

<7> The hygroscopic material according to <6>, in which the water-soluble resin is polyvinyl alcohol having a degree of saponification of 99% or less and a degree of polymerization of 1500 or greater.

<8> The hygroscopic material according to any one of <1> to <7>, in which the hygroscopic layer contains calcium chloride as a hygroscopic agent.

<9> The hygroscopic material according to any one of <1> to <8>, in which the thickness of the resin layer is in a range of 20 μm to 100 μm.

<10> The hygroscopic material according to any one of <1> to <9>, in which the pattern structure is present in a state of being regularly disposed in one direction of the hygroscopic layer.

<11> A packaging material comprising: the hygroscopic material according to any one of <1> to <10>.

<12> A method of producing a hygroscopic material, comprising: forming a patterned adhesive layer on a release substrate using at least one selected from an adhesive, a pressure sensitive adhesive, and a thermoplastic resin; forming a hygroscopic layer on at least one surface of a resin layer (preferably a resin layer having moisture permeability); forming a laminate by bringing the hygroscopic layer formed on the resin layer and the patterned adhesive layer formed on the release substrate into contact with each other and laminating these two layers onto each other; forming a patterned hygroscopic layer (preferably a hygroscopic layer having a non-uniform thickness) on a surface of the resin layer by peeling the release substrate from the laminate so that the hygroscopic layer corresponding to the patterned adhesive layer is peeled off; and forming a damp-proof layer on the patterned hygroscopic layer.

<13> The method of producing a hygroscopic material according to <12>, in which the forming of the patterned adhesive layer includes applying at least one selected from the adhesive, the pressure sensitive adhesive, and the thermoplastic resin onto the release substrate in a pattern shape using a printing method.

<14> A packaging item which is a bonding-formed body of the hygroscopic material according to any one of <1> to <10>.

According to the present disclosure, it is possible to provide a hygroscopic material which has a large hygroscopic capacity and is capable of maintaining excellent hygroscopicity for a long period of time even in a case where a sealing treatment is not performed on an end portion; a method of producing the same; a packaging material; and a packaging item.

### BRIEF DESCRIPTION OF THE DRAWINGS

FIG. 1 is a cross-sectional view schematically illustrating an embodiment of a hygroscopic material of the present invention.

FIG. 2 is a cross-sectional view schematically illustrating another embodiment of a hygroscopic material of the present invention.

FIG. 3 is a cross-sectional view schematically illustrating a layer configuration of a hygroscopic material of the related art.

FIG. 4A is a plan view illustrating a honeycomb pattern as an example of a pattern structure formed of a first region having a thickness A and a second region having a thickness smaller than the thickness A, in a hygroscopic layer.

FIG. 4B is a plan view illustrating a lattice pattern as another example of a pattern structure formed of a first region having a thickness A and a second region having a thickness smaller than the thickness A, in a hygroscopic layer.

FIG. 5A is a view schematically illustrating a part of an example of a production process at the time of producing the hygroscopic material illustrated in FIG. 2.

FIG. 5B is a view schematically illustrating a part of the example of the production process at the time of producing the hygroscopic material illustrated in FIG. 2.

FIG. 5C is a view schematically illustrating a part of the example of the production process at the time of producing the hygroscopic material illustrated in FIG. 2.

FIG. 5D is a view schematically illustrating a part of the example of the production process at the time of producing the hygroscopic material illustrated in FIG. 2.

FIG. 6 is a plan view illustrating an example in which a plurality of pattern structures formed of a rectangular first region having a thickness A and a second region which is disposed at both edges of the first region in a width direction of a hygroscopic layer and one edge of the first region in a direction orthogonal to the width direction of the hygroscopic layer and has a thickness smaller than the thickness A are arranged in the hygroscopic layer.

FIG. 7 is a plan view illustrating another example in which a plurality of pattern structures formed of a rectangular first region having a thickness A and a second region which is disposed at both edges of the first region in a width direction of a hygroscopic layer and one edge of the first region in a direction orthogonal to the width direction of the hygroscopic layer and has a thickness smaller than the thickness A are arranged in the hygroscopic layer.

FIG. 8 is a plan view illustrating still another example in which a plurality of pattern structures formed of a mountain-shaped first region having a thickness A and a second region which is disposed at both edges of the first region in a width direction of a hygroscopic layer and one edge of the first region in a direction orthogonal to the width direction of the hygroscopic layer and has a thickness smaller than the thickness A are arranged in the hygroscopic layer.

### DESCRIPTION OF THE PREFERRED EMBODIMENTS

Hereinafter, a hygroscopic material of the present disclosure, a method of producing the same, and a packaging material obtained by using these will be described in detail.

In the present specification, in a case where the amount of each component in a composition is mentioned and a plurality of materials corresponding to each component in the composition are present, the amount thereof indicates the total amount of the plurality of materials present in the composition unless otherwise noted.

The term “solid content” in the present specification indicates components excluding solvents and the “solid content” in the present specification also contains components in a liquid state such as low-molecular weight components other than solvents.

The numerical ranges shown using “to” in the present specification indicate ranges including the numerical values described before and after “to” as the lower limits and the upper limits, respectively.

<Hygroscopic Material>

According to an embodiment of the present invention, a hygroscopic material includes a resin layer; a hygroscopic layer which has a pattern structure having a first region that has a thickness A and a second region that is present at a peripheral edge of the first region and has a thickness smaller than the thickness A; and a damp-proof layer in this order. The damp-proof layer is provided on the first region and the second region of the hygroscopic layer. It is preferable that the resin layer of the present disclosure is a resin layer having moisture permeability. Further, it is preferable that the hygroscopic layer of the present disclosure is a hygroscopic layer having a non-uniform thickness.

The details of the mechanism on how the hygroscopic material of the embodiment of the present invention exerts effects are not clear, but can be assumed as follows.

In the hygroscopic material of the embodiment of the present invention, in a case where moisture from the outside reaches the hygroscopic layer through the damp-proof layer, the moisture temporarily infiltrates into the first region at an end portion of the hygroscopic material, but moisture permeation into another first region adjacent to the first region into which the moisture has infiltrated is suppressed due to the presence of the damp-proof layer provided on the first region, the second region present at the peripheral edge of the first region, and the damp-proof layer provided on the second region.

Specifically, due to the presence of the second region that is disposed at the peripheral edge of the first region in the hygroscopic layer and has a thickness smaller than the thickness A of the first region along with the function of the damp-proof layer provided in the hygroscopic layer, the mobility of moisture in the second region is significantly decreased compared to the mobility of moisture in the first region. Accordingly, it is considered that the moisture having infiltrated from an end portion of the damp-proof layer is unlikely to permeate into even the first region that is present more inside than the end portion of the hygroscopic material, and thus, for example, the hygroscopic capacity of a region in the vicinity of a product that requires moisture absorption can be excellently maintained for a long period of time. In the hygroscopic material according to the embodiment of the present invention, infiltration of moisture from an end portion of the material, such as a cutting site, to the inside is suppressed. Therefore, it is possible to maintain a desired hygroscopic capacity for a long period of time without requiring a separate sealing treatment.

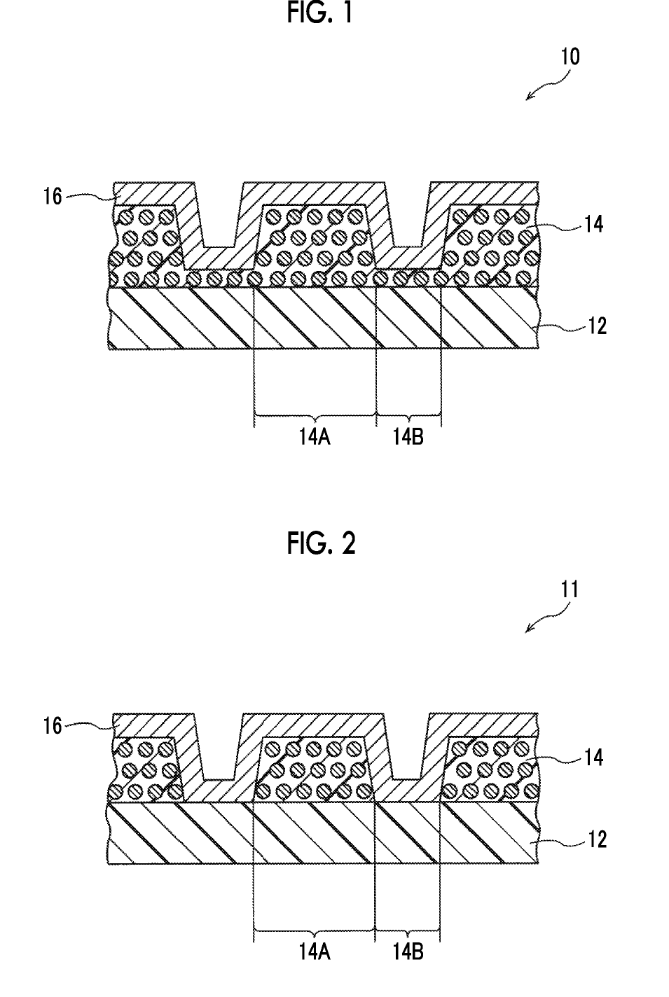

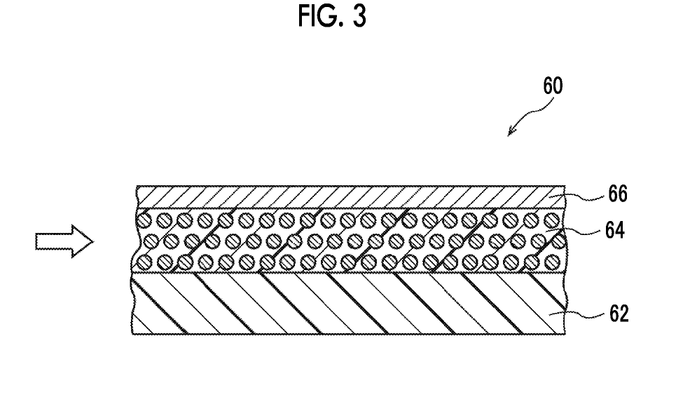

The hygroscopic material according to the embodiment of the present invention will be described in detail with reference to the accompanying drawings. FIG. 1 is a cross-sectional view schematically illustrating a hygroscopic material 10 according to an embodiment of the present invention and FIG. 2 is a cross-sectional view schematically illustrating a hygroscopic material 11 according to another embodiment of the present invention.

As illustrated in FIG. 1, the hygroscopic material 10 includes a resin layer 12 having moisture permeability (hereinafter, also referred to as a “moisture-permeating resin layer”), a hygroscopic layer 14 having a non-uniform thickness, and a damp-proof layer 16 in this order. The hygroscopic layer 14 having a non-uniform thickness in the hygroscopic material 10 has a pattern structure having a first region 14A that has a thickness A and a second region 14B that is present at a peripheral edge of the first region and has a thickness smaller than the thickness A. Meanwhile, the hygroscopic material 11 illustrated in FIG. 2 includes a resin layer 12 having moisture permeability, a hygroscopic layer 14 having a non-uniform thickness, and a damp-proof layer 16 in this order. The hygroscopic layer 14 having a non-uniform thickness in the hygroscopic material 11 has a pattern structure having a first region 14A that has a thickness A and a second region 14B that is present at a peripheral edge of the first region and has a thickness smaller than the thickness A. In other words, in the hygroscopic material of the present disclosure, the thickness of the hygroscopic layer becomes non-uniform because the hygroscopic layer has the first region having a thickness A and the second region that is present at a peripheral edge of the first region and has a thickness smaller than the thickness A.

The structure of the hygroscopic material 10 illustrated in FIG. 1 is configured such that the hygroscopic layer 14 having a small thickness is present in the second region 14B. Meanwhile, the structure of the hygroscopic material 11 illustrated in FIG. 2 is configured such that the hygroscopic layer 14 is not present in the second region 14B.

In other words, in the hygroscopic layer of the hygroscopic material according to the embodiment of the present invention, the thickness of the hygroscopic layer in the second region which is a region having a small thickness may be smaller than the thickness of the hygroscopic layer in the first region. For example, an aspect in which the thickness thereof is zero, that is, the hygroscopic layer is not present in the second region as illustrated in FIG. 2 can also be employed. Therefore, the hygroscopic layer having a non-uniform thickness in the present disclosure is not limited to the aspect illustrated in FIG. 1 and the aspect in which the hygroscopic layers, that is, the first regions having the thickness A are locally present with each other through a void, that is, the second region which does not have the hygroscopic layer as illustrated in FIG. 2 can also be employed.

Here, a hygroscopic material of the related art is illustrated in FIG. 3. FIG. 3 is a cross-sectional view schematically illustrating a hygroscopic material 60 of the related art.

The hygroscopic material 60 of the related art includes a moisture-permeating resin layer 62, a hygroscopic layer 64, and a damp-proof layer 66, and the hygroscopic layer 64 has a uniform thickness. Therefore, in a case where moisture is infiltrated from an end portion of the hygroscopic material 60, that is, from the arrow direction, there is a concern that the infiltrated moisture permeates into even a deep portion of the hygroscopic layer 64. The hygroscopic capacity of the hygroscopic layer 64 is decreased due to the undesired moisture permeation from an end portion of the hygroscopic material 60. In a case where the hygroscopic capacity of the hygroscopic layer is decreased, for example, it becomes impossible to impart required hygroscopic functions to inclusions sealed in a packaging material containing the hygroscopic material in some cases.

In the hygroscopic material (for example, the hygroscopic material 10 in FIG. 1 or the hygroscopic material 11 in FIG. 2) according to the embodiment of the present invention, moisture infiltrated from an end portion infiltrates into the first region (for example, the first region 14A in FIGS. 1 and 2) where the hygroscopic layer of the end portion has the thickness A. However, in the hygroscopic material according to the embodiment of the present invention, moisture permeation into the first region which is adjacent to the first region of the end portion and is present deep inside the hygroscopic material is suppressed due to the presence of the damp-proof layer (for example, the damp-proof layer 16 in FIGS. 1 and 2) included in the first region, the second region (for example, the second region 14B in FIGS. 1 and 2) present at the peripheral edge of the first region, and the damp-proof layer (for example, the damp-proof layer 16 in FIGS. 1 and 2) included in the second region.

Further, due to the presence of the second region that is disposed at the peripheral edge of the first region where the hygroscopic layer according to the embodiment of the present invention has the thickness A and has a thickness smaller than the thickness A along with the function of the damp-proof layer provided in the hygroscopic layer, the mobility of moisture in the second region is significantly decreased compared to the mobility of moisture in the first region. Therefore, it is considered that the moisture infiltrated from an end portion of the hygroscopic layer is unlikely to permeate into even the first region having the thickness A which is present more inside, close to the center of the hygroscopic material than an end portion of the hygroscopic material, and thus it is considered that an excellent hygroscopic capacity is obtained, in particular, in a wide region of the central portion of the hygroscopic material in the vicinity of a product that requires moisture absorption and the excellent hygroscopic capacity is maintained for a long period of time.

According to the hygroscopic material of the present disclosure, even in a case where a long hygroscopic material is continuously produced, cut to have an arbitrary shape and an arbitrary size, and then used, permeation of moisture from the cut end portion of the hygroscopic layer is suppressed at the peripheral edge of the hygroscopic material so that the moisture is unlikely to permeate into even the deep portion, that is, the central portion of the hygroscopic material. Therefore, a hygroscopic material which is capable of maintaining a desired hygroscopic capacity for a long period of time can be obtained without performing a special sealing treatment on the end portion of the hygroscopic material.

In other words, the hygroscopic material of the present disclosure has advantages that it is not necessary to perform a sealing treatment on an end portion of the hygroscopic material after being cut into an arbitrary shape or to produce the hygroscopic material according to the size of a desired package from the beginning and the production efficiency is excellent.

FIG. 1 illustrates the hygroscopic material 10 having the second region 14B where a hygroscopic layer having a thickness smaller than the thickness A of the first region 14A is present at the peripheral edge of the first region 14A, but the present disclosure also includes the hygroscopic material 11 which does not have the hygroscopic layer 14 between the first regions 14A respectively having the thickness A which are adjacent to each other as illustrated in FIG. 2. In a case where the aspect of the hygroscopic material 10 illustrated in FIG. 1 or the aspect of the hygroscopic material 11 illustrated in FIG. 2 is employed, the hygroscopic material of the present disclosure exerts the effects of the present disclosure in both aspects.

The thickness of the hygroscopic layer in the case of the hygroscopic layer having a non-uniform thickness is not necessarily limited to only the two aspects of the hygroscopic layer having the thickness A and the hygroscopic layer having a thickness smaller than the thickness A, and the hygroscopic layer having three or more different thicknesses may be employed. For example, although not illustrated, in the hygroscopic layer, the second region 14B at the peripheral edge of the first region having the thickness A may include a region 14BA having the hygroscopic layer having a thickness smaller than the thickness A and a region 14BB having the hygroscopic layer having a thickness smaller than the thickness of the hygroscopic layer of the region 14AB or may include the region 14BA having the hygroscopic layer having a thickness smaller than the thickness A and a region 14BC which does not have the hygroscopic layer.

From the viewpoints of the magnitude of the hygroscopic capacity, the effects of suppressing moisture transport, and production suitability, the aspect of the hygroscopic layer having two different thicknesses, in which the second region 14B that has the hygroscopic layer having a thickness smaller than the thickness A of the first region 14A is present at the peripheral edge of the first region 14A, and the aspect in which the second region 14B that does not have the hygroscopic layer is present at the peripheral edge of the first region 14A having the thickness A are preferable.

From the viewpoint that the hygroscopic material exhibits an excellent hygroscopic capacity, it is preferable that the thickness A of the hygroscopic layer in the first region is in a range of 20 μm to 50 μm and the thickness of the hygroscopic layer in the second region having a thickness smaller than the thickness A is less than 20% of the thickness of the hygroscopic layer in the first region having the thickness A.

Typically, as the thickness of the hygroscopic layer increases, the content of the hygroscopic agent to be included can be increased and thus the hygroscopic capacity is also increased. In addition, although it depends on the applications of the hygroscopic material 10, in a case where the thickness of the hygroscopic layer is increased, the handleability or the workability with respect to the packaging material or the like may be degraded. In consideration of both the handleability and the workability, the thickness of the hygroscopic layer 14 is preferably in a range of 20 μm to 50 μm and more preferably in a range of 30 μm to 40 μm.

The thickness A of the hygroscopic layer in the first region can be measured by cutting the hygroscopic material in a direction orthogonal to the plane direction of the resin layer having moisture permeability and observing the cross section using an optical microscope.

In a case where the thickness of the hygroscopic layer in the second region is set to be less than 20% of the thickness A of the hygroscopic layer in the first region, the effect of suppressing moisture transport between the first regions respectively having the thickness A which are adjacent to each other becomes more significant. In other words, from the viewpoint of more effectively suppressing the moisture transport, the thickness of the hygroscopic layer in the second region is preferably less than 20% of the thickness A of the hygroscopic layer in the first region having the thickness A, more preferably 15% or less of the thickness A, and still more preferably 10% or less of the thickness A. Further, as illustrated in FIG. 2, the effects of the present disclosure are also exerted even in a case where an aspect in which the second region 14B which does not have the hygroscopic layer is interposed between the first regions 14A respectively having the thickness A which are adjacent to each other and the moisture-permeating resin layer 12 is directly in contact with the damp-proof layer 16 in the second region 14B is employed.

Moreover, the thickness of the hygroscopic layer in the second region can be measured according to the same method as that for the thickness A in the first region described above.

Although not illustrated in FIG. 1, the hygroscopic material of the present disclosure may include layers other than the moisture-permeating resin layer, the hygroscopic layer having a non-uniform thickness, and the damp-proof layer as necessary. Examples of the other layers include an adhesive layer.

In regard to the pattern structure in which the first region where the hygroscopic layer has the thickness A and the second region having a thickness smaller than the thickness A which is present at the peripheral edge of the first region are formed, the occupancy ratio (proportion) of the second region having a thickness smaller than the thickness A of the hygroscopic layer to the entire region of the hygroscopic layer having a non-uniform thickness is preferably 10% or greater and less than 50% in terms of area ratio in a plan view at the time of being seen from a direction orthogonal to the surface of a support which includes the hygroscopic layer.

In other words, it is preferable that the first region having the thickness A is present in a proportion of greater than 50% of the entire region of the hygroscopic layer.

The effect of suppressing moisture transport between first regions adjacent to each other can be sufficiently obtained by setting the area of the second region having a thickness smaller than the thickness A to 10% or greater of the area of the entire region of the hygroscopic layer in a plan view, and a sufficiently large hygroscopic capacity of the hygroscopic material can be achieved by setting the area thereof to less than 50%.

From the viewpoint of obtaining a sufficiently large hygroscopic capacity, the area of the second region with respect to the entire region of the hygroscopic layer is preferably less than 40% and more preferably less than 20% in a plan view.

The area ratio of the area of the second region having a thickness smaller than the thickness A in a plan view to the area of the entire region of the hygroscopic layer is more preferably 10% or greater and less than 40% and still more preferably 15% or greater and less than 20%.

In the hygroscopic material of the present disclosure, the pattern structure formed such that the second region having a thickness smaller than the thickness A of the first region is present at the peripheral edge of the first region is not particularly limited as long as the pattern structure is a structure in which the first region having the thickness A is separated by the second region having a thickness smaller than the thickness A.

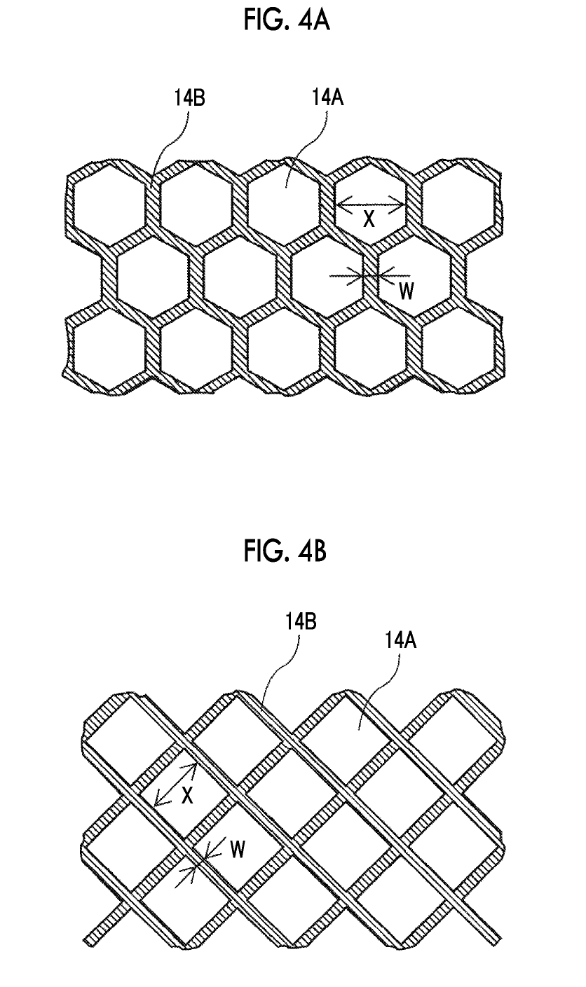

According to a first aspect of the present invention, for example, the first region having the thickness A may be formed in a pattern of a so-called sea-island structure, in which the first region is formed in an island shape in the “second region having a thickness smaller than the thickness A” corresponding to the sea. Examples of the pattern of the sea-island structure include a honeycomb pattern illustrated in FIG. 4A and a lattice pattern illustrated in FIG. 4B. That is, these structures are formed such that structural units of the first region having the thickness A in a hexagonal or square shape are regularly and repeatedly arranged in a state of being separated by the second region having a thickness smaller than the thickness A. FIG. 4A is a plan view illustrating a honeycomb pattern as an example of the pattern structure formed of the first region 14A having the thickness A and the second region 14B having a thickness smaller than the thickness A. Here, the first region 14A is indicated by a white outlined space and the second region 14B is indicated by oblique lines. Further, FIG. 4B is a plan view illustrating a lattice pattern as another example of the pattern structure formed of the first region 14A having the thickness A and the second region 14B having a thickness smaller than the thickness A. Here, the first region 14A is indicated by a white outlined space and the second region 14B is indicated by oblique lines.

The honeycomb pattern and the lattice pattern are respectively a pattern having repeating structures regularly arranged in one direction. According to the present aspect, as described above, in a case of the sea-island structure, in other words, in a case where the first region having the thickness A is separated by the second region having a thickness smaller than the thickness A, the pattern structure of the hygroscopic layer may be, for example, an irregular pattern structure such as a stone-wall structure or a camouflage structure.

Even in a case where the hygroscopic material of the first aspect is cut in an arbitrary position, moisture infiltration from the cutting portion to the inside is suppressed. Therefore, the hygroscopic material of the first aspect has an advantage that the hygroscopic capacity is maintained for a long period of time without performing a separate sealing treatment.

According to the first aspect, from the viewpoint of obtaining a hygroscopic material which is easily produced and is capable of realizing a uniform hygroscopic capacity even in a case where the hygroscopic material is used as a whole or by being cut into a desired size, a pattern having regularly repeating structures is preferable.

In a case of the pattern having repeating structures described above, the area ratio of the “second region having a thickness smaller than the thickness A” to the entire region of the hygroscopic layer can be easily adjusted.

Similar to the pattern structures illustrated in FIGS. 4A and 4B, in a case where the pattern structure is formed such that the structural units in the same shape are regularly arranged, the area ratio of the second region to the entire region of the hygroscopic layer can be easily adjusted. Specifically, the area ratio of the second region 14B to the entire region of the hygroscopic layer 14 can be easily adjusted by adjusting, for example, a width W of the second region 14B, the shape of the pattern structure in a plan view (for example, a hexagonal shape in the case of FIG. 14A and a square shape in the case of FIG. 4B), and a width X of the first region 14A in FIGS. 4A and 4B.

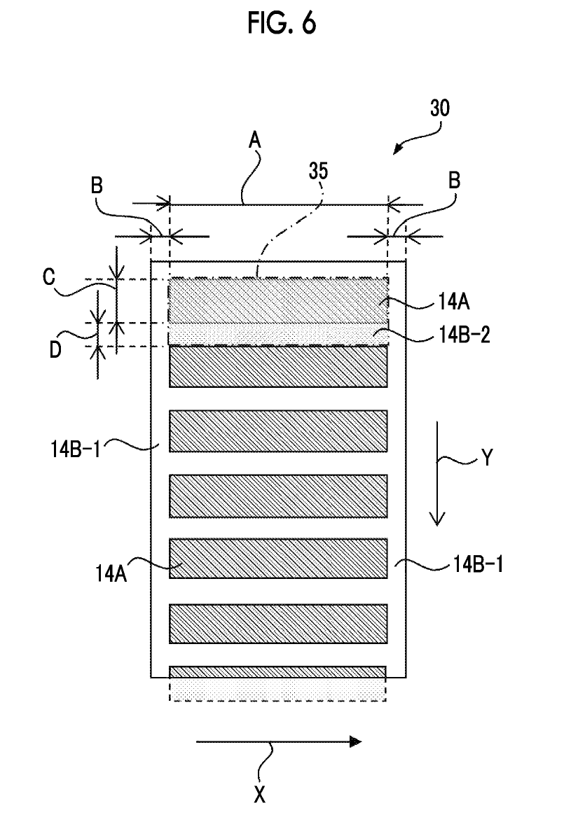

According to a second aspect of the present invention, the hygroscopic material may be, for example, a hygroscopic material 30 as illustrated in FIG. 6. The hygroscopic material 30 includes, in the entire region of the hygroscopic layer, a rectangular first region 14A having a width length A in the width direction (arrow direction X) of the hygroscopic layer and a length C in a direction (arrow direction Y) orthogonal to the width direction; and a second region formed of a region 14B-1 which has a width length B and is disposed in the arrow direction Y at both edges of the first region 14A in the width direction of the hygroscopic layer and a region 14B-2 which has a width length A and a length D and is disposed at one edge of the first region 14A in the arrow direction Y. In addition, a pattern in which a plurality of the regions 35 respectively formed of the first region 14A and the region 14B-2 are disposed in the longitudinal direction (arrow direction Y) may be formed.

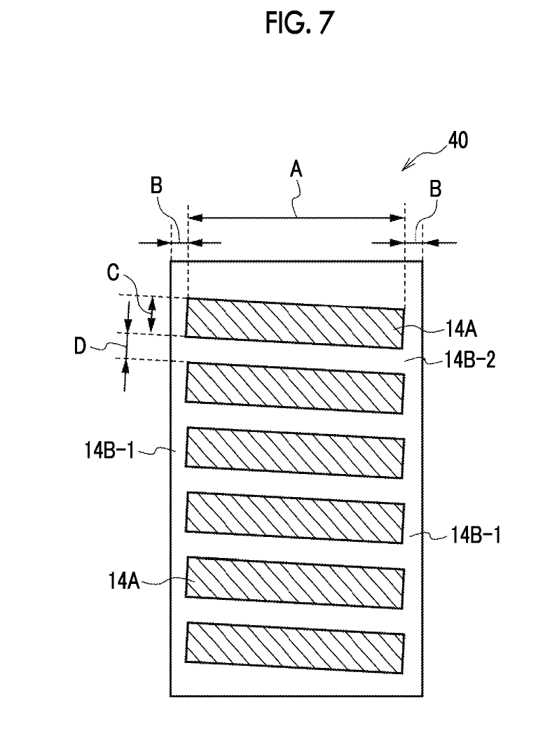

In addition, according to the second aspect of the present invention, the hygroscopic material may be, for example, a hygroscopic material 40 as illustrated in FIG. 7. In FIG. 7, respective reference numerals have the same definitions as those in FIG. 6. In the hygroscopic material 40, the first region 14A is provided such that the longitudinal direction thereof forms an angle with an axis in the lateral direction of the hygroscopic material.

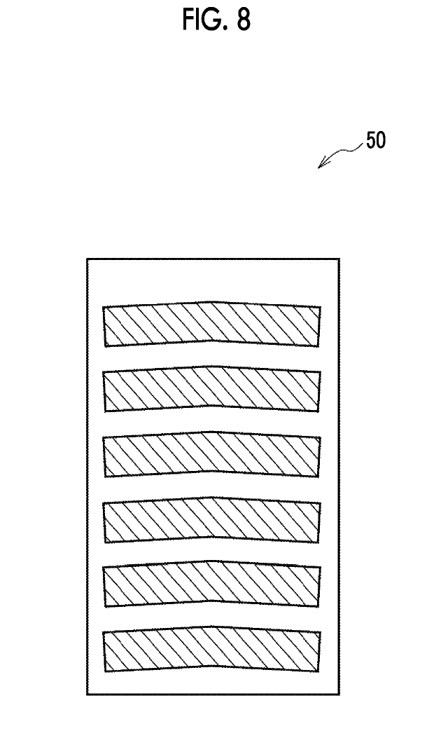

Further, according to the second aspect of the present invention, the hygroscopic material may be, for example, a hygroscopic material 50 illustrated in FIG. 8. In the hygroscopic material 50, the first region has a mountain shape (that is, a shape formed by the central portion of a rectangle being bent in the longitudinal direction).

In the hygroscopic layer according to the second aspect, the first regions (for example, the first regions 14A in FIG. 6) are arranged at equal intervals with a distance corresponding to the length (for example, the length D in FIG. 6) of a region (for example, the region 14B-2 in FIG. 6) which is a part of the second region by arranging a plurality of regions (for example, the regions 35 in FIG. 6).

In the hygroscopic material according to the present aspect, the hygroscopic capacity can be maximized while the hygroscopicity to be required is maintained by disposing a region having a thin hygroscopic layer at both edges of the first region (for example, the first region 14A in FIG. 6) in the width direction (for example, the arrow direction X in FIG. 6) of the material. According to the present aspect, the region having a thin hygroscopic layer can be used as a junction region at the time of packaging.

According to the second aspect, it is preferable that each of two regions (for example, the regions 14B-1 in FIG. 6) which are regions that are present at both edges of the hygroscopic material in the width direction and respectively have the thin hygroscopic layer has a width length (for example, the width length B in FIG. 6), from an end portion of the hygroscopic layer in the width direction, of 3 mm or greater. In a case where the width length is 3 mm or greater, moisture infiltration (moisture absorption) from an end surface is more effectively suppressed. Each width length of two regions (for example, the regions 14B-1 in FIG. 6) which are regions that are present at both edges of the hygroscopic material in the width direction and respectively have the thin hygroscopic layer is more preferably 5 mm or greater from the same viewpoint as described above.

According to the second aspect, the occupancy ratio (proportion) of the area (for example, [D×A] in FIG. 6) of the second region (for example, the region 14B-2 in FIG. 6) that is present at one edge of the first region to the entire area (for example, [(C+D)×A] in FIG. 6) of the first region (for example, the first region 14A in FIG. 6) in a direction (for example, the arrow direction Y in FIG. 6) orthogonal to the width direction of the hygroscopic layer and the second region that is present at one edge of the first region in the direction (for example, the arrow direction Y in FIG. 6) orthogonal to the width direction of the hygroscopic layer is preferably 10% or greater and less than 50% in terms of area ratio in a plan view at the time of being seen from a direction orthogonal to the surface of a support which includes the hygroscopic layer.

In a case where the occupancy ratio of the area of the second region is 10% or greater in a plan view, the effect of suppressing moisture transport between first regions adjacent to each other which respectively have the thick hygroscopic layer is excellent and infiltration of moisture from an end surface is slightly suppressed. Further, in a case where the occupancy ratio of the area of the second region is less than 50% in a plan view, the hygroscopic capacity of the hygroscopic material becomes excellent.

From the viewpoint of the hygroscopic capacity, the occupancy ratio of the area of the second region is more preferably less than 40% and still more preferably less than 20% in a plan view. In addition, the occupancy ratio of the area of the second region is more preferably 10% or greater and less than 40% and still more preferably 15% or greater and less than 20% in a plan view.

Next, each layer in the hygroscopic material according to the embodiment of the present invention will be described below.

Hygroscopic Layer

The hygroscopic layer included in the hygroscopic material 10 of the present disclosure can be used without particular limitation as long as the layer is capable of exhibiting required hygroscopicity.

Examples of the hygroscopic layer include a hygroscopic layer containing a known hygroscopic agent such as silica gel, alumina gel, a molecular sieve, zeolite, or calcium chloride and a resin serving as a dispersion medium; a hygroscopic layer which is a microporous film carrying a hygroscopic agent as described in JP1991-114509A (JP-H03-114509A); and a hygroscopic layer having a porous structure which contains amorphous silica, a water-soluble resin, and a hygroscopic agent.

Among these, from the viewpoints of easily controlling the film thickness of the hygroscopic layer and having an excellent hygroscopic capacity, as the hygroscopic layer in the hygroscopic material of the present disclosure, a hygroscopic layer having a porous structure which contains amorphous silica particles, a water-soluble resin, and a hygroscopic agent and has a porosity of 45% to 85% is preferable. In a case where the hygroscopic layer has a three-dimensional porous structure and the porosity thereof is in a range of 45% to 85%, moisture can be held in a void of the hygroscopic layer in addition to the hygroscopic capacity of the hygroscopic agent so that the hygroscopic capacity of the entire hygroscopic layer becomes excellent.

Hereinafter, as a preferable hygroscopic layer of the present disclosure, the hygroscopic layer having a porous structure will be described in detail.

The preferable hygroscopic layer of the present disclosure has a porous structure containing amorphous silica, a water-soluble resin, and a hygroscopic agent and may further contain a cross-linking agent. Further, the hygroscopic layer may contain other components such as a dispersant or a surfactant as necessary. From the viewpoint of the effects of the present disclosure, amorphous silica having an average secondary particle diameter of 10 μm or less is used as the amorphous silica.

The hygroscopic speed in the hygroscopic layer can be controlled by changing the thickness of the hygroscopic layer or the type of the hygroscopic agent. Further, the hygroscopic speed in the hygroscopic layer can be controlled by changing the thickness of the adhesive layer or the type of the adhesive used for adhesion between layers during lamination.

Amorphous Silica

According to the preferred aspect of the present disclosure, the hygroscopic layer may contain at least one kind of amorphous silica.

The amorphous silica indicates a porous amorphous fine particle in which a three-dimensional structure of SiO₂ is formed and is typically and largely classified into a wet method particle and a dry method (vapor phase method) particle according to the production method thereof. Examples of the amorphous silica include synthetic amorphous silica such as vapor phase method silica obtained using a dry method and wet silica obtained using a wet method.

Vapor Phase Method Silica

The vapor phase method silica is silica (silica fine particles) synthesized by vaporizing a silicon chloride and causing a vapor phase reaction in a hydrogen flame at a high temperature.

Since the vapor phase method silica has a low refractive index, the transparency can be imparted to the hygroscopic layer by performing dispersion up to an appropriate fine particle diameter. From the viewpoint that the contents in packaging can be visually observed and an indicator function or the like can be imparted, it is preferable that the hygroscopic layer is transparent.

Further, the vapor phase method silica and hydrous silica are different from each other in density of a silanol group on the surface and presence of pores and these two exhibit different properties, but the vapor phase method silica is suitable for forming a three-dimensional structure having a high porosity. The reason for this is not clear, but it is assumed that the density of the silanol group on the surface of fine particles is in a range of 5 pcs/nm² to 8 pcs/nm², which is high, so that silica particles tend to be densely aggregated in a case of the hydrous silica; and the density of the silanol group on the surface of fine particles is in a range of 2 pcs/nm² to 3 pcs/nm², which is low, so that silica particles tend to be sparsely flocculated and thus a porous structure with a high porosity is obtained in a case of the vapor phase method silica.

As the vapor phase method silica contained in the hygroscopic layer, vapor phase method silica in which the density of the silanol group on the surface is in a range of 2 pcs/nm² to 3 pcs/nm² is preferable. The average primary particle diameter of the vapor phase method silica contained in the hygroscopic layer is not particularly limited, but is preferably 20 nm or less and more preferably 10 nm or less from the viewpoint of the transparency of the hygroscopic layer.

From the viewpoint of the transparency of the hygroscopic layer, the average secondary particle diameter of the vapor phase method silica contained in the hygroscopic layer is preferably 10 μm or less, more preferably 50 nm or less, and still more preferably 25 nm or less. Further, from the viewpoint of the transparency of the hygroscopic layer, it is preferable that the secondary particle size distribution is uniform, and the standard deviation is preferably 10 nm or less, more preferably 8 nm or less, and still more preferably 5 nm or less.

In a case where the average secondary particle diameter of the vapor phase method silica is 10 μm or less, the transparency and the visibility of the hygroscopic material 10 become excellent.

The average primary particle diameter in the present specification indicates an average diameter of primary particles obtained by observing 100 primary particles using a transmission electron microscope, acquiring the projected area of each particle to obtain the diameter assuming a circle having the same area as the projected area, and simply averaging the diameters of 100 primary particles.

Further, the average secondary particle diameter in the present specification indicates an average diameter of secondary particles obtained by observing 100 aggregated particles using a scanning electron microscope, acquiring the projected area of each particle to obtain the diameter assuming a circle having the same area as the projected area, and simply averaging the diameters of 100 aggregated particles.

Commercially available products may be used as the vapor phase method silica. Examples of the commercially available products of the vapor phase method silica which can be used in the present disclosure include AEROSIL (trade name, manufactured by NIPPON AEROSIL CO., LTD.), REOLOSIL (trade name, manufactured by Tokuyama Corporation), WAKER HDK (trade name, manufactured by Asahi Kasei Corp.), and CAB-O-SIL (trade name, manufactured by Cabot Corporation). Among these, AEROSIL 300 SF75 (trade name, manufactured by NIPPON AEROSIL CO., LTD.) is preferable.

Wet Silica

Wet silica is hydrous silica obtained by generating active silica through acid decomposition of a silicate, properly polymerizing the active silica, and aggregating and precipitating the active silica.

The wet silica is classified into precipitation method silica, gel method silica, and sol method silica according to the production method thereof. The precipitation method silica is obtained by reacting sodium silicate with sulfuric acid under alkaline conditions to produce silica particles, aggregating and precipitating grown silica particles, and performing processes of filtration, washing with water, drying, pulverization, and classification. Examples of the precipitation method silica include NIPSIL (trade name, manufactured by Tosoh Silica Corporation) and TOKUSIL (trade name, manufactured by Tokuyama Corporation). Further, the gel method silica is obtained by reacting sodium silicate with sulfuric acid under acidic conditions, and specific examples thereof include NIPGEL (trade name, manufactured by Tosoh Silica Corporation) and SYLOID and SYLOJET (both trade names, manufactured by Grace Japan K.K.).

The specific surface area of the amorphous silica contained in the hygroscopic layer according to a BET method is preferably 200 m²/g or greater and more preferably 250 m²/g or greater. In a case where the specific surface area of the vapor phase method silica is 200 m²/g or greater, excellent transparency of the hygroscopic layer can be maintained.

The BET method in the present specification is one of the surface area measurement methods for powder using a vapor phase adsorption method and is also a method of acquiring the total surface area of 1 g of a sample from an adsorption isotherm, that is, the specific surface area. Typically, nitrogen gas is frequently used as adsorption gas, and a method of measuring the adsorption amount based on a change in pressure or volume of the adsorbed gas is most frequently used. The Brunauer-Emmett-Teller Equation which is referred to as the BET Equation is the most prominent equation for representing the isotherm of multimolecular adsorption and has been widely used for determination of the surface area. The surface area is obtained by acquiring the adsorption amount based on the BET equation and multiplying the adsorption amount by the area occupied by one adsorbed molecule on the surface.

From the viewpoints of the hygroscopic capacity and the transparency of the hygroscopic layer, the content of the amorphous silica in the hygroscopic layer is preferably in a range of 20% by mass to 80% by mass and more preferably in a range of 30% by mass to 70% by mass with respect to the total solid content of the hygroscopic layer.

As a dispersion method for realizing the secondary particle diameter of the vapor phase method silica in the hygroscopic layer, it is preferable that a dispersant is added thereto and, for example, a cationic polymer can be used. Examples of the cationic polymer include mordants described in paragraphs [0138] to [0148] of JP2006-321176A.

Further, as the dispersion method for realizing the secondary particle diameter of the vapor phase method silica, for example, various known dispersing machines of the related art such as a high-speed rotation dispersing machine, a medium stirring type dispersing machine (such as a ball mill, a sand mill, or a beads mill), an ultrasonic dispersing machine, a colloid mill dispersing machine, or a high-pressure dispersing machine can be used. Among these, a beads mill dispersing machine or a liquid-liquid collision type dispersing machine is preferable and a liquid-liquid collision type dispersing machine is more preferable. Examples of the liquid-liquid collision type dispersing machine include ULTIMIZER (trade name, manufactured by SUGINO MACHINE LIMITED CO., LTD.).

Water-Soluble Resin

The preferable hygroscopic layer of the present disclosure may contain at least one water-soluble resin.

In a case where the hygroscopic layer contain a water-soluble resin, the vapor phase method silica is contained in a state of being more suitably dispersed therein and the strength of the hygroscopic layer is further improved.

The water-soluble resin which can be used in the present disclosure indicates a resin to be finally dissolved in an amount of 0.05 g or greater and preferably 0.1 g or greater in 100 g of water at 20° C. through a heating step or a cooling step.

Examples of the water-soluble resin include a polyvinyl alcohol-based resin which is a resin containing a hydroxy group as a hydrophilic structural unit [such as polyvinyl alcohol (PVA), acetoacetyl-modified polyvinyl alcohol, cation-modified polyvinyl alcohol, anion-modified polyvinyl alcohol, silanol-modified polyvinyl alcohol, or polyvinyl acetal], a cellulose-based resin [such as methyl cellulose (MC), ethyl cellulose (EC), hydroxyethyl cellulose (HEC), carboxymethyl cellulose (CMC), hydroxypropyl cellulose (HPC), hydroxyethyl methyl cellulose, or hydroxypropyl methyl cellulose], chitins, chitosans, starch, a resin having an ether bond [such as polypropylene oxide (PPO), polyethylene glycol (PEG), or polyvinyl ether (PVE)], and a resin containing a carbamoyl group [such as polyacrylamide (PAAM), polyvinylpyrrolidone (PVP), or polyacrylic acid hydrazide]. Further, other examples of the water-soluble resin include polyacrylate containing a carboxyl group as a dissociable group, a maleic acid resin, alginate, and gelatins.

Among the above-described water-soluble resins, from the viewpoint of the film hardness of the hygroscopic layer, a polyvinyl alcohol-based resin is preferable and polyvinyl alcohol is particularly preferable.

The degree of polymerization of the water-soluble resin is preferably 1500 or greater, more preferably 2000 or greater, and still more preferably 3300 or greater. Further, the degree of polymerization thereof is preferably 4500 or less.

From the viewpoint of the film hardness of the hygroscopic layer, the water-soluble resin is a polyvinyl alcohol-based resin, and the degree of polymerization of the polyvinyl alcohol-based resin is preferably 1800 or greater, more preferably 2000 or greater, and still more preferably 2400 or greater. In addition, the degree of polymerization of the polyvinyl alcohol-based resin is more preferably 4500 or less.

The degree of saponification of the water-soluble resin is preferably 99% or less, more preferably 95% or less, and still more preferably 90% or less. Further, the degree of saponification thereof is preferably 70% or greater, more preferably 78% or greater, and still more preferably 85% or greater.

From the viewpoint of the transparency of the hygroscopic layer, the water-soluble resin is a polyvinyl alcohol-based resin, and the degree of saponification of the polyvinyl alcohol-based resin is preferably in a range of 70% to 99%, more preferably in a range of 78% to 99%, and still more preferably in a range of 85% to 99%.

In a case where the degree of saponification of the water-soluble resin is 70% or greater, the resin is practically suitable for maintaining water solubility.

It is preferable that the water-soluble resin used in the hygroscopic layer 14 of the present disclosure is polyvinyl alcohol having a degree of saponification of 99% or less and a degree of polymerization of 3300 or greater.

Further, in a case where polyvinyl alcohol is used as the water-soluble resin and boric acid is used as a cross-linking agent, it is more preferable that the degree of saponification of the polyvinyl alcohol is in a range of 78% to 99% and the degree of polymerization thereof is in a range of 1500 to 4500 and more preferably in a range of 2400 to 3500.

Moreover, in a case where polyvinyl alcohol is used as the water-soluble resin and a cross-linking agent is not used, from the viewpoint that the same porous structure as that in the case of using a cross-linking agent can be formed, it is preferable that the degree of saponification of the polyvinyl alcohol is low and the degree of polymerization thereof is high. Specifically, the degree of saponification of the polyvinyl alcohol is preferably in a range of 78% to 99% and the degree of polymerization of the polyvinyl alcohol is preferably in a range of 2400 to 4500.

Preferred examples of the water-soluble resin also include derivatives of the resins described above as the specific examples.

The water-soluble resin contained in the hygroscopic layer may be used alone or in combination of two or more kinds thereof.

From the viewpoint of preventing a decrease in film hardness and cracking at the time of drying due to the extremely small content of the water-soluble resin and the viewpoint of preventing a decrease in hygroscopicity caused by voids being easily closed by the resin so that the porosity is decreased due to the extremely large content of the water-soluble resin, the content (the total content in a case where two or more kinds of resins are used in combination) of the water-soluble resin in the hygroscopic layer is preferably in a range of 4.0% by mass to 16.0% by mass and more preferably in a range of 6.0% by mass to 14.0% by mass with respect to the total solid content of the hygroscopic layer.

In a case where polyvinyl alcohol is used as the water-soluble resin and boric acid is used as a cross-linking agent of the polyvinyl alcohol, the content of the polyvinyl alcohol in the hygroscopic layer is preferably in a range of 10% by mass to 60% by mass and more preferably in a range of 15% by mass to 30% by mass with respect to the total mass of the amorphous silica. In a case where polyvinyl alcohol is used as the water-soluble resin and a cross-linking agent of the polyvinyl alcohol is not used, the content of the polyvinyl alcohol in the hygroscopic layer is preferably in a range of 25% by mass to 60% by mass with respect to the total mass of the amorphous silica.

The water-soluble resin contains a hydroxyl group in the structural unit thereof, and the hydroxyl group and the silanol group on the surface of the vapor phase method silica form a hydrogen bond so that a three-dimensional network structure using the secondary particles of the vapor phase method silica as a chain unit is easily formed. It is considered that a hygroscopic layer having a porous structure with a high porosity can be formed due to the formation of such a three-dimensional network structure. It is assumed that the obtained hygroscopic layer having a porous structure functions as a layer that holds absorbed moisture.

Further, a preferred aspect of the porosity of the hygroscopic layer and a method of measuring the porosity will be described below.

Cross-Linking Agent

The hygroscopic layer may contain at least one cross-linking agent which is capable of forming a cross-linked structure in the water-soluble resin. It is preferable that the hygroscopic layer contains a cross-linking agent because a cross-linked structure is formed in the layer containing a water-soluble resin, for example, polyvinyl alcohol using a cross-linking reaction and a hygroscopic layer having a porous structure which has been cured at a higher level is formed due to the cross-linked structure.

As the cross-linking agent, a suitable one may be appropriately selected by considering the relationship between the cross-linking agent and the water-soluble resin contained in the hygroscopic layer. From the viewpoint of a rapid cross-linking reaction, a boron compound is preferable as the cross-linking agent. Examples of the boron compound which can be used as the cross-linking agent include borax, boric acid, borate (such as orthoborate, InBO₃, ScBO₃, YBO₃, LaBO₃, Mg₃(BO₃)₂, or Co₃(BO₃)₂), diborate (such as Mg₂B₂O₅ or Co₂B₂O₅), metaborate (such as LiBO₂, Ca(BO₂)₂, NaBO₂, or KBO₂), tetraborate (such as Na₂B₄O₇.10H₂O), pentaborate (such as KB₅O₈.4H₂O, CsB₅O5), and hexaborate (such as Ca₂B₆O₁₁.7H₂O).

Among the examples of the boron compound, from the viewpoint of more rapidly promoting the cross-linking reaction, borax, boric acid, or borate is preferable; boric acid is particularly preferable; and a combination with a polyvinyl alcohol-based resin that is suitably used as a water-soluble resin is most preferable.

Further, in a case of forming the hygroscopic layer having a pattern structure as described in the present disclosure, the hygroscopic layer may not necessarily contain a cross-linking agent. Further, from the viewpoint of further improving the environmental suitability, a configuration in which the hygroscopic layer does not contain a cross-linking agent such as boric acid may be employed.

In a case of preparing the hygroscopic layer containing the cross-linked structure, the content of the boron compound serving as a cross-linking agent is preferably in a range of 0.15% by mass to 5.80% by mass and more preferably in a range of 0.75% by mass to 3.50% by mass with respect to 4.0% by mass to 16.0% by mass of polyvinyl alcohol. In a case where the content of the boron compound is in the above-described range, the polyvinyl alcohol is effectively cross-linked and occurrence of undesired cracks in the hygroscopic layer is suppressed.

In a case where gelatin is used as the water-soluble resin or the like, the following compounds other than the boron compound can be used as a cross-linking agent. The cross-linking agents other than the boron compound serving as cross-linking agents suitable for polyvinyl alcohol are also referred to as “other cross-linking agents” described below.

Examples of other cross-linking agents include an aldehyde-based compound such as formaldehyde, glyoxal, or glutaraldehyde; a ketone-based compound such as diacetyl or cyclopentanediol; an active halogen compound such as bis(2-chloroethylurea)-2-hydroxy-4,6-dichloro-1,3,5-triazine or 2,4-dichloro-6-S-triazine sodium salt; an active vinyl compound such as divinylsulfonic acid, 1,3-vinyl sulfonyl-2-propanol, N,N′-ethylenebis(vinylsulfonylacetamide), or 1,3,5-triacryloyl-hexahydro-S-triazine; a N-methylol compound such as dimethylol urea or methylol dimethyl hydantoin; a melamine resin (such as methylol melamine or alkylated methylol melamine); an epoxy resin; an isocyanate-based compound such as 1,6-hexamethylene diisocyanate; an aziridine-based compound described in the specification of U.S. Pat. No. 3,017,280A and the specification of U.S. Pat. No. 2,983,611A; a carboximide-based compound described in the specification of U.S. Pat. No. 3,100,704A; an epoxy-based compound such as glycerol triglycidyl ether; an ethyleneimino-based compound such as 1,6-hexamethylene-N,N′-bisethylene urea; a halogenated carboxyaldehyde-based compound such as mucochloric acid or mucophenoxychloric acid; a dioxane-based compound such as 2,3-dihydroxy dioxane; a metal-containing compound such as titanium lactate, aluminum sulfate, chrome alum, potash alum, zirconyl acetate, or chromium acetate; a polyamine compound such as tetraethylene pentamine; a hydrazide compound such as adipic acid dihydrazide; and a low-molecular weight compound or a polymer containing two or more oxazoline groups.

Other cross-linking agents may be appropriately selected according to the type of the water-soluble resin used in the hygroscopic layer.

Other cross-linking agents contained in the hygroscopic layer may be used alone or in combination of two or more kinds thereof.

Hygroscopic Agent

The preferable hygroscopic layer of the present disclosure may contain at least one hygroscopic agent.

Examples of the hygroscopic agent include silica gel, alumina gel, zeolite, a water-absorbing polymer, and a hygroscopic salt. Among these, from the viewpoint of the hygroscopic speed, a hygroscopic salt is preferable.

Specific examples of the hygroscopic salt include a halogenated metal salt such as lithium chloride, calcium chloride, magnesium chloride, or aluminum chloride; a metal sulfate such as sodium sulfate, calcium sulfate, magnesium sulfate, or zinc sulfate; a metal acetate such as potassium acetate; an amine salt such as dimethylamine hydrochloride; a phosphoric acid compound such as orthophosphoric acid; a guanidine salt such as guanidine hydrochloride, guanidine phosphate, guanidine sulfamate, guanidine methylol phosphate, or guanidine carbonate; and a metal hydroxide such as potassium hydroxide, sodium hydroxide, and magnesium hydroxide.

Among these, from the viewpoint of an excellent hygroscopic capacity, it is preferable that the hygroscopic agent contains potassium chloride.

The content of the hygroscopic agent in the hygroscopic layer is controlled by the coating amount per unit area. From the viewpoint of achieving both of the hygroscopic capacity and the transparency, the coating amount of the hygroscopic agent is preferably in a range of 1 g/m² to 20 g/m², more preferably in a range of 2.5 g/m² to 15 g/m², and still more preferably in a range of 5 g/m² to 13 g/m².

From the viewpoint of achieving both of the hygroscopic capacity and the transparency, the thickness A of the hygroscopic layer of the present disclosure is preferably in a range of 20 μm to 50 μm, more preferably in a range of 25 μm to 45 μm, and still more preferably in a range of 30 μm to 45 μm. In a case where the thickness A of the hygroscopic layer is in the above-described range, a larger hygroscopic capacity is obtained and both of the hygroscopic capacity and the transparency can be achieved.

Further, as described in the present disclosure, the hygroscopic layer having a porous structure is formed according to a coating method, but the hygroscopic layer having a uniform thickness is difficult to prepare in a case where the thickness A of the hygroscopic layer is greater than 50 μm.

As described above, the porosity of the hygroscopic layer in the hygroscopic material of the present disclosure is preferably in a range of 45% to 85%, more preferably in a range of 50% to 80%, and still more preferably in a range of 55% to 75%. In a case where the porosity of the hygroscopic layer is 45% or greater, a larger hygroscopic capacity is obtained. Further, in a case where the porosity of the hygroscopic layer is 85% or less, a decrease in film hardness can be prevented and cracking at the time of drying can be suppressed.

Examples of the method of measuring the porosity include a mercury press-in method and a calculation method of immersing a hygroscopic layer in an organic solvent such as diethylene glycol to measure the void volume based on a change in mass thereof, and measuring the thickness of the hygroscopic layer through observation of the cross section using a microscope.

It is preferable that the hygroscopic layer of the present disclosure has a thickness of 20 μm to 50 μm and a porosity of 45% to 85%.

The average micropore diameter of the preferable hygroscopic layer of the present disclosure is preferably 40 nm or less, more preferably 30 nm or less, and still more preferably 25 nm or less from the viewpoint of the hygroscopic capacity. In a case where the average micropore diameter of the hygroscopic layer is 40 nm or less, the transparency is sufficiently obtained.

In the present disclosure, the average micropore diameter is a value measured using SHIMADZU AUTOPORE 9220 (trade name, manufactured by Shimadzu Corporation) according to a mercury press-in method.

A method of forming a hygroscopic layer with a non-uniform thickness is not particularly limited. Examples thereof include a method of forming a hygroscopic layer with a uniform thickness and forming roughness on the surface using an emboss roll to make the thickness non-uniform; a method of peeing at least a part of a hygroscopic layer with a uniform thickness and removing the part; a method of locally forming a hygroscopic layer on the surface of a hygroscopic resin layer serving as a substrate according to a printing method or the like; and a method of forming a locally thick hygroscopic layer region and a locally thin hygroscopic region.

Further, a preferable method of producing the hygroscopic material of the present disclosure will be described below.

Resin Layer Having Moisture Permeability (Moisture-Permeating Resin Layer)

In the present disclosure, the hygroscopic material (for example, the hygroscopic material 10 illustrated in FIG. 1 or the hygroscopic material 11 illustrated in FIG. 2) includes the moisture-permeating resin layer (for example, the moisture-permeating resin layer 12 illustrated in FIGS. 1 and 2), the hygroscopic layer with a non-uniform thickness (for example, the hygroscopic layer 14 illustrated in FIGS. 1 and 2), and the damp-proof layer (for example, the damp-proof layer 16 illustrated in FIGS. 1 and 2).

The degree of moisture permeability of the moisture-permeating resin layer is preferably in a range of 1 g/m²·day to 50 g/m²·day. The degree of moisture permeability in the present specification is a value measured according to the method described in JIS Z 0208 (1976). According to the method, a damp-proof packaging material at a temperature of 25° C. is used as a boundary surface, and a value obtained by converting the mass (g) of water vapor passing through the boundary surface for 24 hours into a value per 1 m² of the material is determined as the degree of moisture permeability of the material in a case where air on one side is in a state of a relative humidity of 90% and air on the other side is in a dry state using a hygroscopic agent.

The moisture-permeating resin layer contains at least a film-forming resin and may contain other components as necessary.

Examples of the resin which can be used for the moisture-permeating resin layer include linear low-density polyethylene (LLDPE), low-density polyethylene (LDPE), high-density polyethylene (HDPE), non-stretched polypropylene (CPP), biaxially stretched polypropylene (OPP), and polyacrylonitrile (PAN). From the viewpoint of versatility, LLDPE or CPP is preferable and CPP is more preferable.

The thickness of the moisture-permeating resin layer is preferably in a range of 20 μm to 100 μm and more preferably in a range of 20 μm to 80 μm.

In a case where the thickness of the moisture-permeating resin layer is in the above-described range, both of the handleability of the entire hygroscopic material and handling properties at the time of obtaining the packaging material or the like can be achieved at higher levels.

The hygroscopic speed of the hygroscopic layer can be controlled by adjusting at least any of the quality of the material or the thickness of the moisture-permeating resin layer in the hygroscopic material of the present disclosure.

In a case where the hygroscopic material of the present disclosure is used as the packaging material, the moisture-permeating resin layer can be used as a bonding site. Further, an aspect in which the hygroscopic layer is not in direct contact with the inclusions can be employed in a case where the moisture-permeating resin layer is provided on the side of the inclusions of the packaging material.

Damp-Proof Layer

In the present disclosure, the hygroscopic material includes a damp-proof layer (for example, the damp-proof layer 16 illustrated in FIGS. 1 and 2).

The damp-proof layer is not particularly limited as long as the layer contains a material having dampproofness. It is preferable that the damp-proof layer is a layer having a degree of moisture permeability of less than 1 g/m²·day. As the method of measuring the degree of moisture permeability, the same method as the above-described method used for the moisture-permeating resin layer can be employed.

The damp-proof layer may be a layer formed of one material or may have a laminated structure of layers containing two or more materials.

As the damp-proof layer, a resin film with low moisture permeability in which the moisture permeability satisfies the degree of moisture permeability, a laminate formed of different kinds of resin films, a laminated film obtained by vapor-depositing a metal and an inorganic material on a resin film, or a laminated film formed by laminating a resin film and a metal sheet or the like can be appropriately used.

From the viewpoint of excellent dampproofness, a sheet obtained by vapor-depositing a metal on a resin sheet or paper in advance or a metal sheet such as metal foil may be used.

As the material used for the damp-proof layer, from the viewpoint of obtaining sufficient dampproofness, a laminated film that includes a metal layer or an inorganic material layer such as a silica-deposited film, an alumina-deposited film, or an aluminum-deposited film, or a metal sheet such as aluminum foil is preferable.

Commercially available products may be used as the damp-proof layer. Examples of the commercially available products include TECHBARRIER MX (trade name, manufactured by Mitsubishi Plastics, Inc.) (in other words, silica-deposited PET) and BARRIALOX (trade name, manufactured by TORAY ADVANCED FILM CO., LTD.) (in other words, alumina-deposited PET).

From the viewpoint of dampproofness, the thickness of the damp-proof layer is preferably in a range of 6 μm to 120 μm and more preferably 6 μm to 100 μm.

Adhesive Layer

In the present disclosure, the hygroscopic material may further include an adhesive layer.

The adhesive layer has moisture permeability so that the hygroscopic speed in the hygroscopic layer can be controlled according to the thickness and the type of the adhesive layer. Further, the adhesiveness between the hygroscopic layer (for example, the hygroscopic layer 14 in FIGS. 1 and 2) and the damp-proof layer (for example, the damp-proof layer 16 in FIGS. 1 and 2) and the adhesiveness between the hygroscopic layer and the moisture-permeating resin layer (for example, the moisture-permeating resin layer 12 in FIGS. 1 and 2) can be further strengthened by providing the adhesive layer as desired.

The type of the adhesive used for the adhesive layer is not particularly limited. Examples of the adhesive include a urethane resin-based adhesive, a polyester-based adhesive, an acrylic resin-based adhesive, an ethylene vinyl acetate resin-based adhesive, a polyvinyl alcohol-based adhesive, a polyamide-based adhesive, and a silicone-based adhesive. Among these, from the viewpoint that the adhesive strength is high, a urethane resin-based adhesive is preferable.

It is preferable that the adhesive layer contains at least one urethane resin-based adhesive. Further, a combination of a urethane resin-based adhesive with one or more adhesives other than the urethane resin-based adhesive is also preferably exemplified.

From the viewpoints of the adhesive strength and the handling properties at the time of obtaining the packaging material or the like, the thickness of the adhesive layer is preferably in a range of 3 μm to 15 μm and more preferably in a range of 3 μm to 10 μm. In a case where the thickness of the adhesive layer is in the above-described range, both of the adhesive strength and the handling properties at the time of obtaining the packaging material or the like can be achieved at higher levels.

Further, the hygroscopic speed of the hygroscopic layer can be controlled by selecting the thickness in the above-described range.

The hygroscopic material of the present disclosure may be, for example, a material obtained by laminating the moisture-permeating resin layer 12, the hygroscopic layer 14 with a non-uniform thickness, and the damp-proof layer 16, illustrated in FIG. 1, in this order. From the viewpoint of improving the effect of suppressing moisture permeation between first regions respectively having the thickness A, as the hygroscopic material of the present disclosure, an aspect in which an adhesive is provided between the hygroscopic layer and the damp-proof layer and the hygroscopic layer and the damp-proof layer are bonded to each other through the adhesive layer is also preferable.

Since moisture infiltration from an end portion is suppressed by the second region having the hygroscopic layer and the damp-proof layer even in a case where a sealing treatment is not performed on the end portion so that the moisture does not infiltrate into the deep portion of the hygroscopic material, a sufficiently large hygroscopic capacity can be maintained for a long period of time in a case where the hygroscopic material of the present disclosure is used. Therefore, the hygroscopic material of the present disclosure can be suitably used for the packaging material in order to maintain the dry state of inclusions for a long period of time.

<Method of Producing Hygroscopic Material>

The method of producing the hygroscopic material of the present disclosure is not particularly limited. As the method of forming the hygroscopic layer with a non-uniform thickness, a known method described above can be appropriately selected and then used.

The method of producing the hygroscopic material of the present disclosure includes: forming a patterned adhesive layer on a release substrate using at least one selected from an adhesive, a pressure sensitive adhesive, and a thermoplastic resin; forming a hygroscopic layer on at least one surface of a resin layer (preferably a resin layer having moisture permeability); forming a laminate by bringing the hygroscopic layer formed on the resin layer and the patterned adhesive layer formed on the release substrate into contact with each other and laminating these two layers onto each other; forming a patterned hygroscopic layer (preferably a hygroscopic layer with a non-uniform thickness) on a surface of the resin layer by peeling the release substrate from the laminate so that the hygroscopic layer corresponding to the patterned adhesive layer is peeled off; and forming a damp-proof layer on the patterned hygroscopic layer.

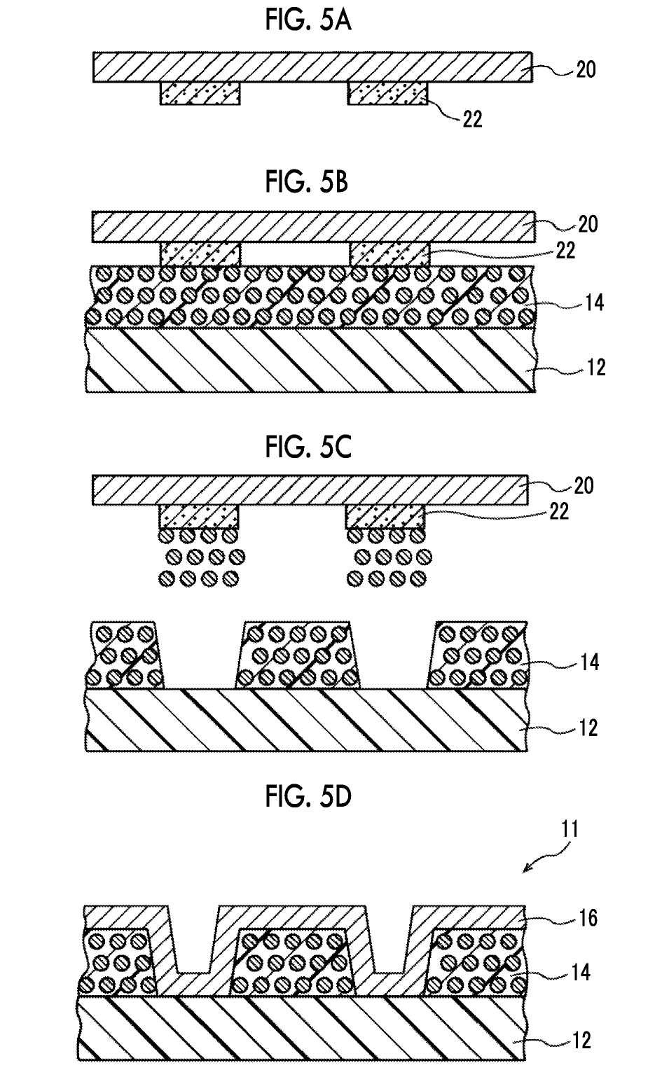

In consideration of the productivity of the hygroscopic layer with a non-uniform thickness, it is preferable that the hygroscopic material is produced according to the following method of producing a hygroscopic material according to an embodiment. The production method of the present disclosure will be described with reference to FIGS. 5A to 5D. FIGS. 5A to 5D are views schematically illustrating production processes as an example of the method of producing the hygroscopic material described using the hygroscopic material 11 illustrated in FIG. 2 as an example.

As an example, a method of producing the hygroscopic material of the present disclosure includes: forming a patterned adhesive layer 22 on a release substrate 20 using at least one selected from an adhesive, a pressure sensitive adhesive, and a thermoplastic resin (hereinafter, also referred to as an adhesive and the like) (see FIG. 5A); forming a hygroscopic layer 14 on at least one surface of a resin layer 12 having moisture permeability (see FIG. 5B); forming a laminate by bringing the formed hygroscopic layer 14 and the patterned adhesive layer 22 formed on the release substrate 20 into contact with each other and laminating these two layers onto each other (see FIG. 5B); forming a hygroscopic layer 14 with an non-uniform thickness on a surface of the resin layer 12 having moisture permeability by peeling the release substrate 20 from the laminate so that the hygroscopic layer corresponding to the patterned adhesive layer 22 is peeled off (see FIG. 5C); and forming a damp-proof layer 16 on the hygroscopic layer 14 with a non-uniform thickness (see FIG. 5D). Further, the production method illustrated in FIGS. 5A to 5D corresponds to the aspect in which the hygroscopic layer is not present in the second region 14B of the hygroscopic layer 14, but the aspect in which the hygroscopic layer is present in the second region 14B having a smaller thickness than that of the first region 14A as illustrated in FIG. 1 can be produced by performing the same process as described above by means of controlling the thickness of the adhesive layer 22, the type of the adhesive used for forming the adhesive layer, the drying conditions, and the like as described below.

Any of the forming of a patterned adhesive layer on a release substrate using at least one selected from an adhesive, a pressure sensitive adhesive, and a thermoplastic resin and the forming of a hygroscopic layer on at least one surface of the resin layer having moisture permeability may be performed first or both may be separately performed in parallel.

As described below, the damp-proof layer with a uniform thickness can be easily formed using a general-purpose coating device. The hygroscopic layer with a uniform thickness is a hygroscopic layer on which the first region having the thickness A is formed. According to the method of closely adhering the adhesive layer to the surface of the hygroscopic layer with a uniform thickness and peeling the adhesive layer from the surface, at least a part of the hygroscopic layer having the thickness A is peeled off and the second region having a thickness smaller than the thickness A is formed. According to the method using the patterned adhesive layer, the hygroscopic layer with a non-uniform thickness which has an arbitrary pattern structure can be easily formed at a desired position of the hygroscopic layer and in a desired shape.

Forming Patterned Adhesive Layer on Release Substrate Using at Least One Selected from Adhesive, Pressure Sensitive Adhesive, and Thermoplastic Resin

In the present step, the patterned adhesive layer 22 is formed on at least one surface of the release substrate 20 using an adhesive or the like, for example, as illustrated in FIG. 5A.

The release substrate 20 used in the present step is capable of stably holding the patterned adhesive layer 22 provided on the release substrate 20 and can be used without particular limitation as long as the release substrate has the strength to the extent that the substrate is not broken while the adhesive layer 22 is bonded to the surface of the hygroscopic layer 14 and then peeled off from the surface.

As the release substrate, a resin sheet or paper obtained by laminating a resin can be used. Among these, from the viewpoints of availability and ease of processing, a resin sheet is preferable. Examples of the resin sheet include a polyester resin such as polyethylene terephthalate (PET) or polyethylene naphthalate (PEN) and a sheet formed of a resin such as polyethylene (PE) or polypropylene (PP). Among these, a PET sheet or the like is preferable.

In a case where a resin sheet is used as the release substrate, a surface treatment performed for the purpose of easy bonding, for example, a corona discharge treatment, may be performed in advance on a side where the adhesive layer is formed.

Commercially available products may be used as the release substrate, and examples thereof include a biaxially stretched PET film LUMIRROR (registered trademark, manufactured by Toray Industries, Inc.).

The method of forming an adhesive layer on a region corresponding to the second region having a thickness smaller than the thickness A, on the surface of the release substrate, is not particularly limited, and a known method can be used.

A patterned adhesive layer can be formed by providing the adhesive layer on the surface of the release substrate in a pattern shape as described above.

Examples of the method of forming the adhesive layer include a printing method such as gravure printing, letterpress printing, inkjet printing, or screen printing; and a method of applying an intermittent coating system of controlling jetting of a liquid using a slot die coating.

Among these, from the viewpoints of easily forming a desired pattern structure and easily forming an adhesive layer having a desired thickness according to the thickness of the hygroscopic layer to be peeled off, it is preferable that at least one selected from an adhesive, a pressure sensitive adhesive, and a thermoplastic resin is provided on the release substrate according to a printing method at the time of forming a patterned adhesive layer on the release substrate using an adhesive or the like.

As illustrated in FIGS. 4A and 4B, gravure printing or screen printing can be used in a case where a pattern structure having regular repetition is formed. For example, according to the gravure printing, a regularly repeating patterned adhesive layer can be easily formed on the surface of the release substrate by preparing a gravure roll on which a regularly repeating pattern structure is formed and using the gravure roll for printing.

In addition, for example, pattern structures other than the regularly repeating pattern structure can be easily formed by applying an inkjet printing method or the like.

The adhesive or the like used for forming an adhesive layer is not particularly limited as long as the adhesiveness between the adhesive and the hygroscopic layer is excellent. From the viewpoint of easily controlling the peeling thickness of the hygroscopic layer, it is preferable that an adhesive or the like which easily permeates into the deep portion of a void of the hygroscopic layer is used in a case where the hygroscopic layer having voids according to the above-described preferred aspect is applied as the hygroscopic layer.

Examples of the adhesive used for forming an adhesive layer include a urethane resin-based adhesive, a polyester-based adhesive, an acrylic resin-based adhesive, an ethylene vinyl acetate resin-based adhesive, a polyvinyl alcohol-based adhesive, a polyamide-based adhesive, and a silicone-based adhesive. Among these, from the viewpoint of excellent adhesive strength between the adhesive and the hygroscopic layer, a urethane resin-based adhesive is preferable.

Commercially available products can be used as the adhesive, and examples of the commercially available products include a urethane resin-based adhesive (trade name: LIS-073-50U, manufactured by TOYO INK CO., LTD.). It is preferable that the adhesive is used in combination with a curing agent (trade name: CR-001, manufactured by TOYO INK CO., LTD.).

Examples of the pressure sensitive adhesive used for forming an adhesive layer include an acrylic pressure sensitive adhesive (trade name: SK-DYNE 1717DT, manufactured by Soken Chemical & Engineering Co., Ltd.).

Examples of the thermoplastic resin used for forming an adhesive layer include a polyester-based thermocompression type adhesive (trade name: SEIKADYNE, manufactured by Dainichiseika Color & Chemicals Mfg. Co., Ltd.)

The adhesive or the like used for forming an adhesive layer may be used alone or in combination of two or more kinds thereof.

The adhesive layer can be formed by providing an adhesive or the like to the release substrate and drying the substrate. The substrate may be dried at room temperature or may be dried by being heated in a temperature range of 40° C. to 120° C. In a case of heating, the substrate is heated according to a method in which the substrate is heated and dried in a state of not being in contact with the adhesive layer, for example, a method of drying the substrate using hot air, a method of passing the substrate through a heating zone, and a method of bringing a heating roll into contact with the release substrate. Among these heating and drying methods, from the viewpoint of productivity, a method of drying the substrate using hot air is preferable.

The thickness of the adhesive layer to be formed may be appropriately selected by considering the thickness of the hygroscopic layer to be applied and the thickness of the hygroscopic layer to be peeled off, that is, the thickness of the second region to remain after the hygroscopic layer is peeled off. Typically, the thickness of the dried adhesive layer is preferably in a range of 3 μm to 15 μm, more preferably in a range of 5 μm to 10 μm, and still more preferably in a range of 6 μm to 8 μm. The thickness of the adhesive layer may be uniform or non-uniform. A hygroscopic layer having three or more different thicknesses can be formed by making the thickness of the adhesive layer non-uniform.

In addition, the hygroscopic layer can be easily peeled off using the adhesive layer by increasing the adhesive strength between the adhesive layer and the hygroscopic layer more than the strength of the hygroscopic layer itself in a case where the hygroscopic layer has self-maintenance performance as in the case of the hygroscopic layer formed by a hygroscopic agent being kneaded in the resin layer.

Further, in a case where the hygroscopic layer is a hygroscopic layer having a porous structure, the dried adhesive layer permeates into voids of the porous structure so that the hygroscopic layer having degraded self-maintenance performance and a relatively fragile porous structure can be peeled off at a deeper position. During the formation of an adhesive layer, aging is typically carried out by storing the hygroscopic layer in a room at around 40° C. for several days in order to promote curing of the adhesive, but the adhesive slightly softens during this time. Therefore, permeation of the adhesive layer into the porous structure of the hygroscopic layer is considered to be promoted. Further, by bringing the adhesive layer and the hygroscopic layer 14 to be into close contact with each other and heating these layers at a temperature of around 40° C., the permeation of the adhesive layer into the porous structure of the hygroscopic layer and curing of the adhesive are promoted and thus the hygroscopic layer can be peeled off at a desired depth.

Forming Hygroscopic Layer on at Least One Surface of Resin Layer Having Moisture Permeation

The production method of the present disclosure includes forming the hygroscopic layer 14 on at least one surface of the resin layer 12 having moisture permeability as illustrated in FIG. 5B.

In the present step, the hygroscopic layer having a uniform thickness is formed on the moisture-permeating resin layer 12. According to the preferred aspect of the present disclosure, the hygroscopic layer contains amorphous silica, a water-soluble resin, and a hygroscopic agent. As an example, in the case of forming the suitable hygroscopic layer described above, a method of forming a hygroscopic layer by coating the moisture-permeating resin layer with a coating solution that contains amorphous silica and a water-soluble resin, forming a layer that has a porous structure, providing a solution that contains a hygroscopic agent for the porous structure, and impregnating the porous structure with the hygroscopic agent can be employed.

By providing the hygroscopic agent for the hygroscopic layer configured so as to have a porous structure obtained by using the coating solution that contains amorphous silica, a state in which the hygroscopic agent is adsorbed on the surface of silica constituting the porous structure is formed. Therefore, the hygroscopic surface can be widely ensured so that the hygroscopic speed increases and the hygroscopic capacity becomes larger. Particularly in a case where the porous structure is formed of vapor phase method silica, transparency is also provided and the hygroscopic material has light transmittance (in other words, visibility through a material).

Since the hygroscopic layer has the porous structure, an adhesive or the like constituting the adhesive layer permeates into the voids of the porous structure of the hygroscopic layer during formation of a laminate by laminating, which is to be continuously performed, the hygroscopic layer formed on the moisture-permeating resin layer and the release substrate on which the adhesive layer is formed on each other. Therefore, it is preferable that the hygroscopic layer has a porous structure because the hygroscopic layer can be easily peeled off up to a desired region which is a deep portion of the hygroscopic layer, into which the adhesive or the like constituting the adhesive layer permeates, at the time of peeling the release substrate and the second region having a desired thickness can be formed.

The coating solution for forming a hygroscopic layer, which is used to form the preferable hygroscopic layer of the present disclosure, can be prepared by mixing amorphous silica, a water-soluble resin, and other components such as a dispersant, water, and/or a cross-linking agent as necessary and performing a dispersing treatment.

For example, vapor phase method silica particles serving as a pigment and a dispersant are added to water and dispersed for a predetermined time (preferably 10 to 30 minutes), for example, under a high-speed rotation condition of 10000 rpm (preferably 5000 to 20000 rpm) using a high-speed rotation wet type colloid mill (for example, trade name: CLEAR MIX, manufactured by M Technique Co., Ltd.) or a liquid-liquid collision type dispersing machine (for example, trade name: ULTIMIZER, manufactured by SUGINO MACHINE LIMITED CO., LTD.), a cross-linking agent (for example, boric acid) and a water-soluble resin (preferably a polyvinyl alcohol aqueous solution) are added thereto, other components are further added thereto as necessary, and the mixture is dispersed therein under the same rotation conditions as described above, thereby preparing a coating solution for forming a hygroscopic layer.

The coating solution to be obtained is a liquid in a sol state with high uniformity, and a hygroscopic layer having a porous structure with a three-dimensional network structure can be formed by coating a support with the coating solution according to an arbitrary coating method and drying the support.

An aqueous dispersion containing amorphous silica and a dispersant may be prepared by preparing an amorphous silica aqueous dispersion liquid in advance and adding the obtained aqueous dispersion liquid to a dispersant aqueous solution, by adding the dispersant aqueous solution to the amorphous silica aqueous dispersion liquid, or by mixing amorphous silica and the dispersant at the same time. In addition, powdery amorphous silica may be added to the dispersant aqueous solution as described above without using the amorphous silica aqueous dispersion liquid.

An aqueous dispersion liquid having an average particle diameter of 20 nm to 5000 nm can be obtained by mixing amorphous silica and a dispersant with each other and finely granulating the obtained mixed solution using a dispersing machine. Particularly in a case of using vapor phase method silica as the amorphous silica, an aqueous dispersion liquid having an average particle diameter of 20 nm to 100 nm can be obtained.

As the dispersing machine, various known dispersing machines of the related art, such as a high-speed rotation dispersing machine, a medium stirring type dispersing machine (a ball mill, a sand mill, or the like), an ultrasonic dispersing machine, a colloid mill dispersing machine, or a high-pressure dispersing machine, can be used. Among these, a stirring type dispersing machine, a colloid mill dispersing machine, and a high-pressure dispersing machine are preferable.

A solvent can be used for preparation of the coating solution. Examples of the solvent include water, an organic solvent, and a mixed solvent of these. Examples of the organic solvent include alcohols such as methanol, ethanol, n-propanol, i-propanol, and methoxypropanol, ketones such as acetone and methyl ethyl ketone, tetrahydrofuran, acetonitrile, ethyl acetate, and toluene.

The coating solution can be applied according to a coating method using a blade coater, an air knife coater, a roll coater, a bar coater, a gravure coater, or a reverse coater.

After the coating solution is applied, the hygroscopic layer is dried until showing a decreasing rate of drying. The hygroscopic layer may be dried typically in a temperature range of 40° C. to 180° C. for 0.5 minutes to 10 minutes and preferably for 0.5 minutes to 5 minutes.

In a case where the hygroscopic layer having a porous structure is formed, a layer is coated with the coating solution and dried to form a layer (coating layer) having a porous structure, and a solution that contains a basic compound, for example, an ammonium salt of a weak acid such as ammonium carbonate, an alkali metal salt of a weak acid, an alkaline earth metal salt of a weak acid, hydroxyammonium, primary to tertiary amine, primary to tertiary aniline, or pyridine may be provided for the formed layer. A porous structure having an excellent pore structure is obtained by performing this process.

Examples of the method of providing a solution containing a basic compound include a method of further coating the hygroscopic layer with a solution, a method of spraying a solution using a spray or the like, and a method of immersing a support on which a coating layer has been formed in a solution containing a basic compound.

In addition, the solution containing a basic compound may be provided simultaneously with application of the coating solution for forming a hygroscopic layer. In this case, a layer having a porous structure can be obtained by simultaneously coating (multilayer-coating) the support with the coating solution and the solution containing a basic compound such that the coating solution is brought into contact with the support and drying and curing the coating layer.

As described above, after the layer having a porous structure is formed, a solution containing a hygroscopic agent is provided for the layer and the porous structure is impregnated with the hygroscopic agent, thereby forming a hygroscopic layer having voids.

Examples of the method of providing a solution containing a hygroscopic agent include a method of coating the hygroscopic layer with a solution, a method of spraying a solution using a spray or the like, and a method of immersing the layer having a porous structure in a solution.

In a case where the solution containing a hygroscopic agent is provided for the layer by coating the layer with the solution, the same coating method as the method used for the coating solution for forming a hygroscopic layer may be exemplified as the coating method.

The solution containing a hygroscopic agent contains at least one hygroscopic agent and may contain other components such as a surfactant and/or a solvent as necessary.

The solution containing a hygroscopic agent can be prepared by adding a hygroscopic agent (for example, an inorganic salt) and additives such as a surfactant as necessary to ion exchange water and stirring the solution.

From the viewpoints of the hygroscopic amount and the hygroscopic speed of the hygroscopic layer, the amount of the solution containing the hygroscopic agent is determined such that the amount of the hygroscopic agent to be provided is set to be preferably in a range of 1 g/m² to 20 g/m² and more preferably in a range of 3 g/m² to 12 g/m².

After the solution containing a hygroscopic agent is provided, the layer is heated typically in a temperature range of 40° C. to 180° C. for 0.5 minutes to 30 minutes, dried, and then cured. It is preferable that the layer is heated in a temperature range of 40° C. to 150° C. for 1 minute to 20 minutes. For example, in a case where the solution contains borax or boric acid as a boron compound, it is preferable that the layer is heated in a temperature range of 60° C. to 100° C. for 0.5 minutes to 15 minutes.

Forming Laminate by Bringing Hygroscopic Layer Formed on Resin Layer Having Moisture Permeability and Patterned Adhesive Layer Formed on Release Substrate into Contact with Each Other and Laminating these Two Layers onto Each Other

Next, for example, a laminate is formed by bringing the hygroscopic layer 14 formed on the moisture-permeating resin layer 12 and the patterned adhesive layer 22 formed on the release substrate 20 into contact with each other and laminating these two layers onto each other as illustrated in FIG. 5B. The lamination may be performed by passing the laminate through a space between a pair of smooth rollers at room temperature or heat lamination may be performed by passing the laminate through a space between rollers which have been heated at 30° C. to 100° C.

A laminate formed by bringing the hygroscopic layer 14 and the adhesive layer 22 into close contact with each other is formed by performing the present step.

Forming Hygroscopic Layer Having Non-Uniform Thickness on Surface of Resin Layer Having Moisture Permeability by Peeling Release Substrate from Laminate so that Hygroscopic Layer Corresponding to Patterned Adhesive Layer is Peeled Off

In the present step, the release substrate 20 is peeled off from the laminate as illustrated in FIG. 5C. The hygroscopic layer 14 in a region in close contact with the adhesive layer 22 formed in a pattern shape on the surface of the release substrate 20 is peeled in a pattern shape according to the region where the adhesive layer 22 is formed by peeling the release substrate 20 from the laminate, and the second region 14B having a thickness smaller than the thickness A, which is the thickness of the original hygroscopic layer, is formed in a pattern shape after the peeling. The thickness A of the initially formed hygroscopic layer 14 is maintained in the region where the adhesive layer 22 is not formed, the region becomes the first region 14A, and the hygroscopic layer 14 having a non-uniform thickness is formed on the surface of the moisture-permeating resin layer 12. For example, in the peeling of the hygroscopic layer 14 in the present step, the hygroscopic layer 14 may not be entirely peeled off in the thickness direction of the region where the adhesive layer 22 is formed unlike FIG. 5C. In a case where at least a part thereof is peeled off in the thickness direction of the hygroscopic layer, the second region having a thickness smaller than the thickness A is formed and the hygroscopic layer becomes a hygroscopic layer having a non-uniform thickness. In addition, a hygroscopic layer having three or more different thicknesses may be formed.

Forming Damp-Proof Layer on Hygroscopic Layer Having Non-Uniform Thickness

By performing the pre-step, the hygroscopic layer 14 having a non-uniform thickness is formed on the moisture-permeating resin layer 12. In the present step, for example, the damp-proof layer 16 is formed on a side, with roughness, of the obtained hygroscopic layer 14 having a non-uniform thickness, which is the side opposite to the moisture-permeating resin layer 12 as illustrated in FIG. 5D, and then the hygroscopic material is obtained.

The method of forming the damp-proof layer is not particularly limited, and the damp-proof layer may be formed by adhering a material having dampproofness onto the hygroscopic layer having a non-uniform thickness provided on the moisture-permeating resin layer. In addition, the damp-proof layer may be formed by preparing a coating solution containing a material having dampproofness, coating the hygroscopic layer having a non-uniform thickness with the coating solution, and drying the resulting layer.

Among examples of the method, from the viewpoints of sufficiently following the roughness of the hygroscopic layer having a non-uniform thickness and efficiently forming the damp-proof layer having excellent adhesiveness, it is preferable that the damp-proof layer is formed by adhesion.

As described in the section of the hygroscopic material, a layer formed of a material having a degree of moisture permeability of less than 1 g/m²·day is preferable as the damp-proof layer, and it is preferable that the layer is formed using a resin film having a single layer structure or a laminated structure with low moisture permeability, a film on which a metal or an inorganic material is vapor-deposited, or the like.

The damp-proof layer can be formed by bonding the above-described film used for forming a damp-proof layer to a side, with roughness, of the hygroscopic layer having a non-uniform thickness.

From the viewpoints of further improving the adhesiveness between the damp-proof layer and the hygroscopic layer and more effectively suppressing moisture transport between first regions respectively having the thickness A which are adjacent to each other in the hygroscopic layer, it is preferable that the adhesive layer is formed on the film for forming a damp-proof layer during the formation of the damp-proof layer and the hygroscopic layer and the damp-proof layer are bonded to each other through the adhesive layer. By interposing the adhesive layer between the hygroscopic layer and the damp-proof layer, the damp-proof layer is strongly bonded to the hygroscopic layer along the roughness of the hygroscopic layer having a non-uniform thickness and the function of suppressing moisture permeation into the second region having a thickness smaller than the thickness A is further improved.

<Packaging Material and Packaging Item>

The hygroscopic material according to the embodiment of the present invention may be used as a packaging material. The packaging material is a packaging material containing the above-described hygroscopic material of the embodiment of the present invention. Examples of the form of the packaging material include a sheet form and a bag form.

Further, a packaging item of the embodiment of the present invention is a bonding-formed product obtained by bonding a part of the above-described hygroscopic material of an embodiment of the present invention to form the product, for example, in a bag form. For example, in a case of the packaging material bonding-formed in a bag form, it is possible to package a packaged product by enclosing the product in the packaging material. The bonding may be performed by thermal fusion (for example heat sealing), and a site to which a part of the hygroscopic material is bonded is formed to obtain a packaging item.

Hereinafter, the packaging material will be described using a packaging material that contains a hygroscopic material in a sheet form as an example.

In a case where the hygroscopic material according to the embodiment of the present invention is used as a packaging material, the packaging material can be used in the form described below, but the form of the packaging material is not limited to the following examples.

As a first aspect of the packaging material, an aspect in which a hygroscopic material in one sheet form is formed into a bag form by setting the moisture-permeating resin layer to face the inside and the damp-proof layer to face the outside, a bonding site formed by bonding at least some portions of the moisture-permeating resin layer is provided at the peripheral edge in the bag form, and the inclusions that require moisture absorption are put inside the packaging material may be exemplified.

In a case of a material in which the moisture-permeating resin layer can be thermally fused, the bonding site may be formed by thermal fusion (for example, heat sealing) or may be formed by bonding a pair of moisture-permeating resin layers to each other through an adhesive layer, an easily adhesive sheet, or the like.

As the method of forming the packaging material 10 in a bag form, in addition to a method of folding one sheet of hygroscopic material and bonding overlapping moisture-permeating resin layers to each other at the end portion, a method of overlapping two sheets of hygroscopic materials by setting the moisture-permeating resin layer to face the inside and the damp-proof layer to face the outside and bonding the moisture-permeating resin layers at the end portion to each other may be exemplified.

Examples of other aspects of the packaging material include an aspect in which moisture-permeating resin layers of two different kinds of hygroscopic materials overlap each other and the peripheral edges are bonded to each other to obtain a bag form and an aspect in which a damp-proof sheet and a hygroscopic material overlap each other by bringing a moisture-permeating resin layer side of the hygroscopic material into contact with the damp-proof sheet and the peripheral edges are bonded to each other to obtain a bag form.

Further, a hygroscopic material provided with a recess serving as a housing portion is obtained by forming the hygroscopic material in advance, and the form of the packaging material including a housing portion which is formed by bonding the moisture-permeating resin layer in a portion where a recess is not formed on an opening surface side of the recess of the hygroscopic material to another damp-proof sheet can be obtained.

As a specific example, the packaging material of the present disclosure can also be applied to blister pack (also referred to as PTP packaging) used for packaging medicine or the like which is provided with a recess housing inclusions.

In addition to the description above, as a second aspect of the packaging material, a packaging item including a packaged product is obtained by bonding two regions which are regions (for example, the region 14B-1 in FIG. 6) in the thin hygroscopic layer which are present at both edges of the hygroscopic material in the width direction to form a bag form using the hygroscopic material according to the second aspect described above and further bonding an upper end portion and a lower end portion of the hygroscopic material in the longitudinal direction (for example, the arrow direction Y in FIG. 6) so as to be sealed.

Examples of the packaging form include pillow packaging, four-sided seal bag packaging, three-sided seal bag packaging, gusset packaging, and standing bag packaging.

The size of the packaging depends on the size of the packaged product, but is typically and preferably in a range of 30 mm to 500 mm in terms of external dimensions.

Even in all the forms of the packaging material, as the bonding method, a known bonding method such as thermocompression bonding, thermal fusion, ultrasonic bonding, bonding through an adhesive, or bonding through an easily adhesive sheet can be applied according to the purpose thereof.

The packaging material of the present disclosure is capable of maintaining the dry state of inclusions for a long period of time because infiltration of moisture from the cutting end portion to the deep portion of the hygroscopic material constituting the packaging material is suppressed without performing a sealing treatment on the end portion and a sufficiently large hygroscopic capacity can be maintained for a long period of time.

### EXAMPLES

Hereinafter, the present invention will be described in more detail with reference to examples, but the present invention is not limited to the following examples unless the present invention goes beyond the gist thereof. Further, “part” and “%” are on a mass basis unless otherwise noted.

### Examples 1 to 24

In the following processes, hygroscopic materials of the examples and comparative examples were prepared by following the configurations of hygroscopic materials listed in Tables 2 to 4.

<Formation of Hygroscopic Layer>

Preparation of Coating Solution for Forming Hygroscopic Layer

As shown in the following composition, (1) vapor phase method silica 1, (2) ion exchange water, (3) SHALLOL DC-902P (trade name), and (4) ZIRCOSOL ZA-30 were mixed and dispersed using a liquid-liquid collision type dispersion machine (ULTIMIZER, manufactured by SUGINO MACHINE LIMITED CO., LTD.) (this step is referred to as a silica dispersing treatment as appropriate). Thereafter, the obtained dispersion liquid was heated at 45° C. and held for 20 minutes. Next, the dispersion liquid was held at 30° C., (5) and a boric acid aqueous solution and (6) a polyvinyl alcohol (PVA)-dissolved solution were added to the dispersion liquid, thereby preparing a coating solution for forming a hygroscopic layer.

Composition of Coating Solution for Forming Hygroscopic Layer

| | |
|---|---|
| (1) Vapor phase method silica 1 (amorphous silica) | 8.9 parts |
| (trade name: AEROSIL 300 SF75, manufactured by | |
| NIPPON AEROSIL CO., LTD., average primary particle | |
| diameter: 7 nm, average secondary particle diameter: | |
| 20 nm) | |
| (2) Ion exchange water | 47.3 parts |
| (3) SHALLOL DC-902P (51.5% aqueous solution) | 0.8 parts |
| (trade name, manufactured by DKS Co., Ltd., dispersant, | |
| nitrogen-containing organic cationic polymer) | |
| (4) ZIRCOSOL ZA-30 | 0.5 parts |
| (trade name, manufactured by DAIICHI KIGENSO | |
| KAGAKU KOGYO CO., LTD., zirconyl acetate) | |
| (5) Boric acid (5% aqueous solution) | 6.6 parts |
| (6) Polyvinyl alcohol (water-soluble resin)-dissolved | 26.0 parts |
| solution | |

Composition of Polyvinyl Alcohol-Dissolved Solution

| | |
|---|---|
| Polyvinyl alcohol (PVA) | 1.81 parts |
| (1) Examples 1 to 17 and 19 to 24: JM33 | |
| (trade name, manufactured by JAPAN VAM & POVAL CO., | |
| LTD, polyvinyl alcohol (PVA); degree of saponification: | |
| 95.5%, degree of polymerization: 3300) | |
| (2) Example 18: JP33 | |
| (trade name, manufactured by JAPAN VAM & POVAL CO., | |
| LTD, polyvinyl alcohol (PVA); degree of saponification: | |
| 88%, degree of polymerization: 4500) | |
| HPC-SSL | 0.08 parts |
| (trade name, manufactured by Nippon Soda Co., Ltd., | |
| water-soluble cellulose) | |
| Ion exchange water | 23.5 parts |
| Diethylene glycol monobutyl ether | 0.55 parts |
| (trade name: BUTYCENOL 20p, manufactured by | |
| Kyowa Hakko Chemical Co., Ltd.) | |
| Polyoxyethylene lauryl ether (surfactant) | 0.06 parts |
| (trade name: EMULGEN 109P, manufactured by Kao | |
| Corporation) | |

Formation of Hygroscopic Layer

A linear low-density polyethylene (LLDPE) sheet (hereinafter, also referred to as an LLDPE sheet) having a thickness listed in Tables 2 to 4 was used as a moisture-permeating resin layer. The LLDPE sheet serving as a moisture-permeating resin layer was coated with the coating solution for forming a hygroscopic layer obtained in the above-described manner using an extrusion die coater such that the coating amount thereof was set to 165 g/m².

A coating layer formed by coating the sheet was dried under conditions of a temperature of 80° C. at a wind speed of 3 m/sec to 8 m/sec using a hot air dryer until the concentration of solid contents of the coating layer was set to 36%. The coating layer during the drying exhibited the constant rate of drying. Immediately after the drying was finished, the coating layer was immersed in a liquid containing a basic compound with the following composition for 3 seconds, and the liquid containing the basic compound was allowed to adhere to the coating layer such that the coating amount thereof was set to 13 g/m². Further, the coating layer was dried in an environment of 72° C. for 10 minutes, thereby forming a layer having a porous structure.

Thereafter, the formed layer was coated with a hygroscopic agent coating solution with the following composition using an extrusion die coater such that the coating amount thereof was set to 50 g/m² (in other words, CaCl₂ application amount: 7 g/m²) and dried under conditions of a temperature of 80° C. at a wind speed of 3 m/sec to 8 m/sec using a hot air dryer, thereby obtaining a hygroscopic layer having a thickness of 40 μm.

The porosity of the formed hygroscopic layer was 60% and the average micropore size thereof was 20 nm.

Composition of Liquid Containing Basic Compound

| | |
|---|---|
| (1) Boric acid | 0.65 parts |
| (2) Ammonium carbonate (primary, manufactured by | 5.0 parts |
| Kanto Chemical Co., Inc.) | |
| (3) Ion exchange water | 93.75 parts |
| (4) Polyoxyethylene lauryl ether (surfactant) | 0.6 parts |
| (trade name: EMULGEN 109P, manufactured by Kao | |
| Corporation) | |

Composition of Hygroscopic Agent Coating Solution

| | |
|---|---|
| (1) Ion exchange water | 85.4 parts |
| (2) Calcium chloride (CaCl₂, hygroscopic agent) | 14.0 parts |
| (3) Polyoxyethylene lauryl ether (surfactant) | 0.6 parts |
| (trade name: EMULGEN 109P, manufactured by | |
| Kao Corporation) | |

Formation of Adhesive Layer Pattern

A polyethylene terephthalate (PET) base (registered trademark: LUMIRROR, manufactured by Toray Industries, Inc.) was used as a release substrate. One surface of the release substrate was coated in a pattern shape with an adhesive mixture formed by mixing a urethane resin-based adhesive LIS-073-50U (trade name, manufactured by Toyo Ink Mfg. Co., Ltd.) serving as an adhesive with CR-001 (trade name, manufactured by Toyo Ink Mfg. Co., Ltd.) serving as a curing agent according to a direct gravure printing method.

According to the direct gravure printing method, a gravure roll in which a repeating pattern structure was engraved in accordance with the region where the adhesive layer was formed was prepared and used for printing, in other words, application of an adhesive.

An adhesive was applied to the PET base such that the thickness of the dried adhesive layer was set to 7 μm according to the direct gravure printing method, the layer was dried at 60° C. for 1 minute, and a patterned adhesive layer having a thickness of 7 μm after being dried was formed.

The pattern structure of the adhesive layer 22 used in each example is listed in Table 1.

As the pattern structure, the honeycomb pattern illustrated in FIG. 4A and the lattice pattern illustrated in FIG. 4B were applied. In the size of each pattern, the width of the first region 14A having a thickness of 40 μm was expressed as a width X (described as “X dimension” in Table 1) and the width of the second region 14B having a thickness smaller than 40 μm was expressed as a width W (described as “W dimension” in Table 1).

TABLE 1

| | Examples | | | | | |
|---|---|---|---|---|---|---|
| | 1, 5, 7 to | | | | | |
| | 10, 12, 13, 16 | | | | Examples | |
| | to 20, 23, | | Examples | | 11, 14, and | Examples |
| | and 24 | Example 3 | 2 and 6 | Example 4 | 21 | 15 and 22 |
| Pattern | Honeycomb | Honeycomb | Lattice | Lattice | Honeycomb | Honeycomb |
| shape | | | | | | |
| X dimension | 10 | 25 | 10 | 25 | 7 | 29 |
| (mm) | | | | | | |
| W dimension | 3 | 3 | 3 | 3 | 4 | 1 |
| (mm) | | | | | | |

Preparation of Hygroscopic Layer with Non-Uniform Thickness

A laminate was formed by bringing the hygroscopic layer with a uniform thickness which was formed on the moisture-permeating resin layer obtained in the above-described manner and the patterned adhesive layer which was formed on the surface of the release substrate into contact with each other and laminating these two layers onto each other. The lamination was performed by passing the laminate through a space between a pair of smooth rollers which had been heated at 60°.

Next, the release substrate was peeled off from the laminate so that the hygroscopic layer in the region where the adhesive layer was formed was peeled off while being brought into close contact with the adhesive layer. As the result, a hygroscopic layer with a non-uniform thickness which had, in the pattern structure, the first region having the hygroscopic layer with a thickness of 40 μm that had not been peeled off in a region where the adhesive layer was not formed and the region which had the hygroscopic layer partially peeled off due to the adhesive layer and had a thickness smaller than that of the first region was formed.

The thickness of the hygroscopic layer in the second region after peeling and the thickness ratio of the thickness of the hygroscopic layer in the second region to the thickness of the hygroscopic layer in the first region are listed in Tables 2 to 4.

Adhesion of Damp-Proof Layer

A silica-deposited surface of silica-deposited PET (trade name: TECH BARRIER MX, manufactured by Mitsubishi Plastics, Inc.) serving as a damp-proof layer was coated with an adhesive (that is, mixture of LIS-073-50U (trade name) serving as a urethane resin-based adhesive and CR-001 (trade name) serving as a curing agent, manufactured by TOYO INK CO., LTD.) such that the coating amount thereof after drying of the layer was set to have a thickness of 3.5 μm. The obtained silica-deposited PET was repeatedly dry-laminated on the hygroscopic layer with a non-uniform thickness formed on the moisture-permeating resin layer in a direction in which the surface on which the hygroscopic layer was formed was in contact with the adhesive so that the two layers were allowed to adhere to each other. In this manner, a hygroscopic material was obtained.

The obtained hygroscopic material had a laminated structure of the LLDPE sheet serving as a moisture-permeating resin layer, the hygroscopic layer with a non-uniform thickness, the adhesive layer, and the silica-deposited PET serving as a damp-proof layer (in other words, the adhesive layer was formed on the silica-deposited surface of the silica-deposited PET).

Comparative Examples 1 and 2

A hygroscopic layer was formed in the same manner as in Example 1 and a damp-proof layer was allowed to adhere to the surface of the hygroscopic layer with a uniform thickness in the same manner as in Example 1 to obtain a hygroscopic material for comparison except that a hygroscopic layer having a uniform thickness of 40 μm (Comparative Example 1) and a hygroscopic layer having a uniform thickness of 30 μm (Comparative Example 2) were formed without peeling each hygroscopic layer using the adhesive layer in Example 1.

Evaluation

The following evaluations were performed on the hygroscopic material obtained in the above-described manner. The evaluation results are listed in Tables 2 to 4.

<Hygroscopic Capacity>

The hygroscopic capacity of the hygroscopic material was evaluated in the following manner.

A sample of the hygroscopic material having a size of 100 mm×100 mm was stored in a thermohygrostat bath under a temperature condition of 60° C. at a relative humidity of 10% for 1 hour and dried. The mass of the sample immediately after being transferred to an environment at a temperature of 23° C. and a relative humidity of 50% was measured and was set as the mass in a dry state. Thereafter, a change in mass with time was measured and the hygroscopic capacity was acquired from the mass at the time at which the mass did not change anymore.

<Evaluation Standard>

A: The hygroscopic capacity under a temperature condition of 23° C. at a relative humidity of 50% was 10 g/m² or greater.

B: The hygroscopic capacity under a temperature condition of 23° C. at a relative humidity of 50% was 8 g/m² or greater and less than 10 g/m².

C: The hygroscopic capacity under a temperature condition of 23° C. at a relative humidity of 50% was 6 g/m² or greater and less than 8 g/m².

D: The hygroscopic capacity under a temperature condition of 23° C. at a relative humidity of 50% was 3 g/m² or greater and less than 6 g/m².

E: The hygroscopic capacity under a temperature condition of 23° C. at a relative humidity of 50% was less than 3 g/m².

Further, the standards A to C are in levels with no practical problems.

<Hygroscopic Amount from End Surface>

The hygroscopic amount of the hygroscopic material from the end surface was evaluated in the following manner.

Two sheets of samples of the hygroscopic material having a size of 100 mm×100 mm were stored in a thermohygrostat bath under a temperature condition of 60° C. at a relative humidity of 10% for 1 hour and dried. Thereafter, two sheets of samples of the hygroscopic material and the LLDPE sheet side serving as the moisture-permeating resin layer were allowed to combine and overlap each other, the peripheral edges of the four sides were heat-sealed, and two sheets were bonded to each other to obtain a sample for measuring the hygroscopic amount from the end surface.

The mass of the obtained sample immediately after being transferred to an environment at a temperature of 23° C. and a relative humidity of 50% was measured and was set as the mass in a dry state. Thereafter, the sample was stored in an environment at a temperature of 23° C. and a relative humidity of 50% for 30 days, the mass of the sample with time was measured, a difference between the mass in a dry state and the mass with time was set as the hygroscopic amount from the end surface, and the evaluation was performed based on the following standard.

<Evaluation Standard>

A: The hygroscopic amount from the end surface was less than 0.3 g/m².

B: The hygroscopic amount from the end surface was 0.3 g/m² or greater and less than 0.5 g/m².

C: The hygroscopic amount from the end surface was 0.5 g/m² or greater and less than 1.0 g/m².

D: The hygroscopic amount from the end surface was 1.0 g/m² or greater and less than 2.0 g/m².

E: The hygroscopic amount from the end surface was 2.0 g/m² or greater.

Further, the standards A to C are in levels with no practical problems.

<Porosity>

The porosity of the hygroscopic layer was acquired from the void volume per unit thickness to be calculated from the void volume (ml/m²) and the thickness (μm) of the hygroscopic layer.

The porosity was measured with respect to the hygroscopic layer before the peeling step using an adhesive was performed, and the thickness of the hygroscopic layer was acquired from the results of observation using an optical microscope. Further, the void volume of the hygroscopic layer was obtained by adding 1 ml of diethylene glycol dropwise onto the hygroscopic layer, wiping the dropped surface with cloth after 1 minute from the dropping, and calculating the change in mass before and after the dropwise addition (in other words, the amount of the absorption liquid per unit area). This calculated value was set as the void volume. Further, the porosity of the hygroscopic layer in the hygroscopic material already prepared can be measured using a sample obtained by cutting the first region 14A.

TABLE 2

| | Configuration of hygroscopic material | | | | | |
|---|---|---|---|---|---|---|
| | | | | | Thickness | |
| | | | | | ratio of | |
| | | | | Thickness | hygroscopic | |
| | Hygroscopic | | Area | of | layer in | Porosity of |
| | layer with | | ratio | hygroscopic | second | hygroscopic |
| | non-uniform | Pattern | (second | layer in first | region | layer |
| | thickness | structure | region) | region (μm) | (%) | (%) |
| Example 1 | Available | Honeycomb | 40% | 40 | 10 | 60 |
| Example 2 | Available | Lattice | 40% | 40 | 10 | 60 |
| Example 3 | Available | Honeycomb | 20% | 40 | 10 | 60 |
| Example 4 | Available | Lattice | 20% | 40 | 10 | 60 |
| Example 5 | Available | Honeycomb | 40% | 40 | 18 | 60 |
| Example 6 | Available | Lattice | 40% | 40 | 18 | 60 |
| Example 7 | Available | Honeycomb | 40% | 30 | 13 | 60 |
| Example 8 | Available | Honeycomb | 40% | 40 | 20 | 60 |
| Example 9 | Available | Honeycomb | 40% | 20 | 10 | 60 |

| | Configuration of | | | Evaluation of | |
|---|---|---|---|---|---|
| | hygroscopic material | | | performance | |
| | Degree of | | | | Hygroscopic |
| | saponification | Degree of | Thickness of | | amount |
| | of PVA | polymerization | moisture-permeating | Hygroscopic | from end |
| | (%) | of PVA | resin layer (μm) | capacity | surface |
| Example 1 | 95.5 | 3300 | 20 | A | A |
| Example 2 | 95.5 | 3300 | 20 | A | A |
| Example 3 | 95.5 | 3300 | 20 | A | B |
| Example 4 | 95.5 | 3300 | 20 | A | B |
| Example 5 | 95.5 | 3300 | 20 | A | B |
| Example 6 | 95.5 | 3300 | 20 | A | B |
| Example 7 | 95.5 | 3300 | 20 | B | A |
| Example 8 | 95.5 | 3300 | 20 | A | B |
| Example 9 | 95.5 | 3300 | 20 | B | A |

TABLE 3

| | Configuration of hygroscopic material | | | | | |
|---|---|---|---|---|---|---|
| | | | | | Thickness | |
| | | | | | ratio of | |
| | | | | Thickness | hygroscopic | |
| | Hygroscopic | | Area | of | layer in | Porosity of |
| | layer with | | ratio | hygroscopic | second | hygroscopic |
| | non-uniform | Pattern | (second | layer in first | region | layer |
| | thickness | structure | region) | region (μm) | (%) | (%) |
| Example 10 | Available | Honeycomb | 40% | 50 | 10 | 60 |
| Example 11 | Available | Honeycomb | 60% | 40 | 10 | 60 |
| Example 12 | Available | Honeycomb | 40% | 40 | 10 | 40 |
| Example 13 | Available | Honeycomb | 40% | 40 | 10 | 85 |
| Example 14 | Available | Honeycomb | 60% | 40 | 10 | 60 |
| Example 15 | Available | Honeycomb | 7% | 40 | 10 | 60 |
| Example 16 | Available | Honeycomb | 40% | 15 | 10 | 60 |
| Example 17 | Available | Honeycomb | 40% | 40 | 30 | 60 |
| Example 18 | Available | Honeycomb | 40% | 40 | 10 | 60 |

| | Configuration of | | | Evaluation of | |
|---|---|---|---|---|---|
| | hygroscopic material | | | performance | |
| | Degree of | | | | Hygroscopic |
| | saponification | Degree of | Thickness of | | amount |
| | of PVA | polymerization | moisture-permeating | Hygroscopic | from end |
| | (%) | of PVA | resin layer (μm) | capacity | surface |
| Example 10 | 95.5 | 3300 | 20 | A | A |
| Example 11 | 95.5 | 3300 | 20 | B | A |
| Example 12 | 95.5 | 3300 | 20 | B | A |
| Example 13 | 95.5 | 3300 | 20 | A | A |
| Example 14 | 95.5 | 3300 | 20 | C | A |
| Example 15 | 95.5 | 3300 | 20 | A | C |
| Example 16 | 95.5 | 3300 | 20 | C | A |
| Example 17 | 95.5 | 3300 | 20 | A | C |
| Example 18 | 88 | 4500 | 20 | A | A |

TABLE 4

| | Configuration of hygroscopic material | | | | | |
|---|---|---|---|---|---|---|
| | | | | | Thickness | |
| | | | | | ratio of | |
| | | | | Thickness | hygroscopic | |
| | Hygroscopic | | Area | of | layer in | Porosity of |
| | layer with | | ratio | hygroscopic | second | hygroscopic |
| | non-uniform | Pattern | (second | layer in first | region | layer |
| | thickness | structure | region) | region (μm) | (%) | (%) |
| Example 19 | Available | Honeycomb | 40% | 40 | 10 | 60 |
| Example 20 | Available | Honeycomb | 40% | 40 | 10 | 60 |
| Example 21 | Available | Honeycomb | 60% | 40 | 10 | 60 |
| Example 22 | Available | Honeycomb | 7% | 40 | 10 | 60 |
| Example 23 | Available | Honeycomb | 40% | 15 | 10 | 60 |
| Example 24 | Available | Honeycomb | 40% | 40 | 30 | 60 |
| Comparative | Not | — | — | 40 | — | 60 |
| Example 1 | available | | | | | |
| | (uniform | | | | | |
| | layer) | | | | | |
| Comparative | Not | — | — | 30 | — | 60 |
| Example 2 | available | | | | | |
| | (uniform | | | | | |
| | layer) | | | | | |

| | Configuration of | | | | |
|---|---|---|---|---|---|
| | hygroscopic material | | | Evaluation of | |
| | Degree of | | | performance | |
| | saponification | Degree of | Thickness of | | Hygroscopic |
| | of PVA | polymerization | moisture-permeating | Hygroscopic | amount from |
| | (%) | of PVA | resin layer (μm) | capacity | end surface |
| Example 19 | 95.5 | 3300 | 100 | A | A |
| Example 20 | 95.5 | 3300 | 80 | A | A |
| Example 21 | 95.5 | 3300 | 20 | C | A |
| Example 22 | 95.5 | 3300 | 20 | A | C |
| Example 23 | 95.5 | 3300 | 20 | C | A |
| Example 24 | 95.5 | 3300 | 20 | A | C |
| Comparative | 95.5 | 3300 | 20 | A | E |
| Example 1 | | | | | |
| Comparative | 95.5 | 3300 | 20 | B | D |
| Example 2 | | | | | |

As listed in Tables 2 to 4, it was understood that the hygroscopic material of each example has a large hygroscopic capacity and absorption of moisture from an end portion is suppressed even in a case where a special sealing treatment is not performed on the end portion.

On the contrary, in a case of the hygroscopic materials of Comparative Examples 1 and 2 which respectively have a hygroscopic layer with a uniform thickness, it was understood that, even though the initial hygroscopic capacity is in a level with no practical problems, the moisture absorption amount from an end portion is large so that it is difficult to expect maintenance of an excellent hygroscopic capacity for a long period of time and to use the hygroscopic materials for a long period of time.

### Examples 25 to 39

By carrying out the same process as in Example 1, a hygroscopic material having the same pattern structure as illustrated in FIG. 6 was prepared, and pillow packaging or gusset packaging was performed using the prepared hygroscopic material according to the following method. The details of the pattern structure are listed in Table 5. Further, the hygroscopic capacity in the packaging form and the hygroscopic amount from an end surface were evaluated. The evaluation was performed according to the same method as in Example 1 or the like. The evaluation results are listed in Table 5.

Further, in the pattern structures listed in Table 5, the A pattern indicates the structure illustrated in FIG. 6 and the B pattern indicates the structure illustrated in FIG. 7.

In the pillow packaging, a pillow package was prepared by, for example, bonding second regions 14B-1 with a width length B, which were provided on both edges of the first region 14A in FIG. 6, in a bag form and further bonding the upper end and the lower end to each other.

In the gusset packaging, a stick-like gusset package was prepared by, for example, bonding second regions 14B-1 with a width length B, which were provided on both edges of the first region 14A in FIG. 6, in a bag form and further bonding the upper end and the lower end to each other.

Comparative Examples 3 and 4

Pillow packaging was performed in the same manner as in Example 25 or the like using the hygroscopic materials for comparison prepared in Comparative Examples 1 and 2. Further, the hygroscopic capacity in the packaging form and the hygroscopic amount from an end surface were evaluated. The evaluation was performed according to the same method as in Example 1 or the like. The evaluation results are listed in Table 5.

TABLE 5

| | | | Width | Width length | | | | | |
|---|---|---|---|---|---|---|---|---|---|
| | | | length A of | B of both | Length C | | | Thickness | Thickness |
| | | | first region | edges of first | of first | Length | | of first | ratio of |
| | Hygroscopic | | in | region in | region of | D of | | region | second |
| | layer with | | hygroscopic | hygroscopic | hygroscopic | second | | (thick | region (thin |
| | non-uniform | Pattern | layer | layer | layer | region | | region) | region) |
| | thickness | structure | [mm] | [mm] | [mm] | [mm] | D/(C + D) | [μm] | [%] |
| Example 25 | Available | Width | 100 | 5 | 20 | 3 | 13% | 40 | 10 |
| | | regulating A | | | | | | | |
| | | pattern | | | | | | | |
| Example 26 | Available | Width | 106 | 2 | 20 | 3 | 13% | 40 | 10 |
| | | regulating A | | | | | | | |
| | | pattern | | | | | | | |
| Example 27 | Available | Width | 100 | 5 | 15 | 5 | 25% | 40 | 10 |
| | | regulating A | | | | | | | |
| | | pattern | | | | | | | |
| Example 28 | Available | Width | 100 | 5 | 30 | 2 | 6% | 40 | 10 |
| | | regulating A | | | | | | | |
| | | pattern | | | | | | | |
| Example 29 | Available | Width | 100 | 5 | 20 | 25 | 56% | 40 | 10 |
| | | regulating A | | | | | | | |
| | | pattern | | | | | | | |
| Example 30 | Available | Width | 50 | 5 | 10 | 2 | 17% | 40 | 10 |
| | | regulating A | | | | | | | |
| | | pattern | | | | | | | |
| Example 31 | Available | Width | 56 | 2 | 10 | 2 | 17% | 40 | 10 |
| | | regulating A | | | | | | | |
| | | pattern | | | | | | | |
| Example 32 | Available | Width | 50 | 5 | 20 | 1.5 | 7% | 40 | 10 |
| | | regulating A | | | | | | | |
| | | pattern | | | | | | | |
| Example 33 | Available | Width | 290 | 5 | 20 | 3 | 13% | 40 | 10 |
| | | regulating A | | | | | | | |
| | | pattern | | | | | | | |
| Example 34 | Available | Width | 296 | 2 | 20 | 3 | 13% | 40 | 10 |
| | | regulating A | | | | | | | |
| | | pattern | | | | | | | |
| Example 35 | Available | Width | 290 | 5 | 30 | 2 | 6% | 40 | 10 |
| | | regulating A | | | | | | | |
| | | pattern | | | | | | | |
| Example 36 | Available | Width | 100 | 5 | 15 | 5 | 25% | 40 | 10 |
| | | regulating A | | | | | | | |
| | | pattern | | | | | | | |
| Example 37 | Available | Width | 100 | 5 | 15 | 5 | 25% | 40 | 10 |
| | | regulating B | | | | | | | |
| | | pattern | | | | | | | |

| | | | | | |
|---|---|---|---|---|---|
| Example 38 | Available | Honeycomb | — | 40 | 10 |
| Example 39 | Available | Lattice | — | 40 | 10 |
| Comparative | Not | — | — | 40 | — |
| Example 3 | available | | | | |
| | (uniform | | | | |
| | layer) | | | | |
| Comparative | Not | — | — | 30 | — |
| Example 4 | available | | | | |
| | (uniform | | | | |
| | layer) | | | | |

| | | | | | Evaluation | | |
|---|---|---|---|---|---|---|---|
| | | | | Thickness of | | | Hygroscopic |
| | | Degree of | | moisture- | | Hygroscopic | amount from |
| | | saponification | Degree of | permeating | | capacity in | end surface |
| | Porosity | of PVA | polymerization of | resin layer | Packaging | packaging | in packaging |
| | [%] | [%] | PVA | [μm] | material | form | form |
| Example 25 | 60 | 95.5 | 3300 | 20 | Pillow | A | B |
| | | | | | packaging | | |
| Example 26 | 60 | 95.5 | 3300 | 20 | Pillow | A | C |
| | | | | | packaging | | |
| Example 27 | 60 | 95.5 | 3300 | 20 | Pillow | A | A |
| | | | | | packaging | | |
| Example 28 | 60 | 95.5 | 3300 | 20 | Pillow | A | C |
| | | | | | packaging | | |
| Example 29 | 60 | 95.5 | 3300 | 20 | Pillow | C | A |
| | | | | | packaging | | |
| Example 30 | 60 | 95.5 | 3300 | 20 | Pillow | A | B |
| | | | | | packaging | | |
| Example 31 | 60 | 95.5 | 3300 | 20 | Pillow | C | C |
| | | | | | packaging | | |
| Example 32 | 60 | 95.5 | 3300 | 20 | Pillow | B | C |
| | | | | | packaging | | |
| Example 33 | 60 | 95.5 | 3300 | 20 | Pillow | A | B |
| | | | | | packaging | | |
| Example 34 | 60 | 95.5 | 3300 | 20 | Pillow | C | C |
| | | | | | packaging | | |
| Example 35 | 60 | 95.5 | 3300 | 20 | Pillow | C | C |
| | | | | | packaging | | |
| Example 36 | 60 | 95.5 | 3300 | 20 | Gusset | A | A |
| | | | | | packaging | | |
| Example 37 | 60 | 95.5 | 3300 | 20 | Pillow | A | A |
| | | | | | packaging | | |
| Example 38 | 60 | 95.5 | 3300 | 20 | Pillow | A | B |
| | | | | | packaging | | |
| Example 39 | 60 | 95.5 | 3300 | 20 | Pillow | A | B |
| | | | | | packaging | | |
| Comparative | 60 | 95.5 | 3300 | 20 | Pillow | A | E |
| Example 3 | | | | | packaging | | |
| Comparative | 60 | 95.5 | 3300 | 20 | Pillow | B | D |
| Example 4 | | | | | packaging | | |

As listed in Table 5, it was understood that the hygroscopic material in each example has a large hygroscopic capacity and the effect of suppressing moisture absorption from an end portion is excellent in a case where the hygroscopic material is formed into the packaging form. In addition, the hygroscopic material having the pattern structure illustrated in FIG. 6 or 7 tends to have excellent sealing properties in an end surface compared to the hygroscopic materials of Examples 38 and 39 which have a honeycomb pattern or a lattice pattern in which the cutting surface becomes the hygroscopic layer (first region) with the thickness A.

On the contrary, in the hygroscopic material of each comparative example in which the hygroscopic layer with a uniform thickness is formed, the effect of suppressing moisture absorption from an end portion in a case where the hygroscopic material is formed into the packaging form is small and the maintenance of the hygroscopic capacity for a long period of time cannot be expected.

The disclosures of JP2015-195102 filed on Sep. 30, 2015 and JP2016-189771 filed on Sep. 28, 2016 are incorporated in the present specification by reference in their entirety.

All documents, patent applications, and technical standards described in the present specification are incorporated herein by reference to the same extent as a case of being specifically and individually noted that individual documents, patent applications, and technical standards are incorporated by reference.

What is claimed is:

1. A hygroscopic material comprising:
a resin layer;
a hygroscopic layer; and
a damp-proof layer in this order,
wherein the hygroscopic layer has a pattern structure having a first region that has a thickness A and a second region that is present at a peripheral edge of the first region and has a thickness smaller than the thickness A, and
the damp-proof layer is provided on the first region and the second region.

2. The hygroscopic material according to claim 1,
wherein an occupancy ratio of the second region which has a thickness smaller than the thickness A to the entire region of the hygroscopic layer is 10% or greater and less than 50% in terms of area ratio in a plan view.

3. The hygroscopic material according to claim 1,
wherein the pattern structure of the hygroscopic layer is a structure having the first region and the second region which is disposed at both edges of the first region in a width direction of the hygroscopic layer and at least one edge of the first region in a direction orthogonal to the width direction of the hygroscopic layer and has a thickness smaller than the thickness A,
a plurality of the structures are disposed in a longitudinal direction orthogonal to the width direction of the hygroscopic layer, and
the occupancy ratio of the second region, which is present at at least one edge of the first region in a direction orthogonal to the width direction of the hygroscopic layer and has a thickness smaller than the thickness A, to the total of the first region and the second region in the direction orthogonal to the width direction of the hygroscopic layer is 10% or greater and less than 50% in terms of area ratio in a plan view.

4. The hygroscopic material according to claim 3,
wherein at least one of the second region disposed at both edges of the first region has a width length of 3 mm or greater from an end portion of the hygroscopic layer in the width direction.

5. The hygroscopic material according to claim 1,
wherein the thickness A of the hygroscopic layer in the first region is in a range of 20 μm to 50 μm, and
the thickness of the hygroscopic layer in the second region having a thickness smaller than the thickness A is less than 20% of the thickness of the hygroscopic layer in the first region having the thickness A.

6. The hygroscopic material according to claim 1,
wherein the hygroscopic layer has a porous structure containing amorphous silica particles, a water-soluble resin, and a hygroscopic agent, and
the porosity of the hygroscopic layer is in a range of 45% to 85%.

7. The hygroscopic material according to claim 6,
wherein the water-soluble resin is polyvinyl alcohol having a degree of saponification of 99% or less and a degree of polymerization of 1500 or greater.

8. The hygroscopic material according to claim 1,
wherein the hygroscopic layer contains calcium chloride as a hygroscopic agent.

9. The hygroscopic material according to claim 1,
wherein the thickness of the resin layer is in a range of 20 μm to 100 μm.

10. The hygroscopic material according to claim 1,
wherein the pattern structure is present in a state of being regularly disposed in one direction of the hygroscopic layer.

11. A packaging material comprising:
the hygroscopic material according to claim 1.

12. A method of producing a hygroscopic material, comprising:
forming a patterned adhesive layer on a release substrate using at least one selected from an adhesive, a pressure sensitive adhesive, and a thermoplastic resin;
forming a hygroscopic layer on at least one surface of a resin layer;
forming a laminate by bringing the hygroscopic layer formed on the resin layer and the patterned adhesive layer formed on the release substrate into contact with each other and laminating these two layers onto each other;
forming a patterned hygroscopic layer on a surface of the resin layer by peeling the release substrate from the laminate so that the hygroscopic layer corresponding to the patterned adhesive layer is peeled off; and
forming a damp-proof layer on the patterned hygroscopic layer.

13. The method of producing a hygroscopic material according to claim 12,
wherein the forming of the patterned adhesive layer includes applying at least one selected from the adhesive, the pressure sensitive adhesive, and the thermoplastic resin onto the release substrate in a pattern shape using a printing method.

14. A packaging item which is a bonding-formed body of the hygroscopic material according to claim 1.
